(19) United States
(12) Patent Application Publication
(10) Pub. No.: US 2021/0224633 A1
(43) Pub. Date: Jul. 22, 2021

(54) SELF ORGANIZATION OF NEUROMORPHIC MACHINE LEARNING ARCHITECTURES

(71) Applicant: California Institute of Technology, Pasadena, CA (US)

(72) Inventors: Guruprasad Raghavan, Pasadena, CA (US); Matthew W. Thomson, Pasadena, CA (US); Cong Lin, Pasadena, CA (US)

(21) Appl. No.: 17/127,762

(22) Filed: Dec. 18, 2020

Related U.S. Application Data
(60) Provisional application No. 62/949,586, filed on Dec. 18, 2019.
(60) Provisional application No. 63/039,739, filed on Jun. 16, 2020.

(51) Int. Cl. G06N 3/04; G06N 3/08

(52) U.S. Cl. CPC G06N 3/049; G06N 3/08

(57) ABSTRACT

Disclosed herein include systems, methods, devices, and computer readable media for constructing a neural network by growing and self-organizing.

### CROSS-REFERENCE TO RELATED APPLICATIONS

This application claims the benefit of priority to U.S. Patent Application No. 62/949,586, filed on Dec. 18, 2019, the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

### Field

This disclosure relates generally to the field of machine learning, and more particularly to neural networks.

### Background

Living neural networks in the brain perform an array of computational and information processing tasks including sensory input processing, storing and retrieving memory, decision making, and more globally, generate the general phenomena of “intelligence”. In addition to their information processing feats, brains are unique because they are computational devices that actually self-organize their intelligence. In fact brains ultimately grow from single cells during development. Engineering has yet to construct artificial computational systems that can self-organize their intelligence.

### SUMMARY

Disclosed herein include methods for constructing a neural network. In some embodiments, a method for constructing a neural network is under control of a hardware processor and comprises: growing, from at least one node, a plurality of layers of a neural network each comprises a plurality of nodes. The method can comprise: self-organizing the plurality of layers of the neural network to alter inter-layer connectivity between the lower first layer and the higher second layer, using spatiotemporal waves in a lower first layer of the plurality of layers of the neural network, and/or a learning rule implemented in a higher second layer of the plurality of layers of the neural network connected to the lower first layer of the plurality of layers of the neural network. In some embodiments, the hardware processor comprises a neuromorphic processor.

In some embodiments, the at least one node comprises a single node. In some embodiments, growing, from the at least one node, the plurality of layers of the neural network comprises dividing the at least one node to generate a daughter node, of the at least one node, in the lower first layer. In some embodiments, the method comprises dividing the daughter node in the lower first layer to generate a further daughter node, of the daughter node of the at least one node, in the lower first layer. In some embodiments, the method comprises dividing the daughter node in the lower first layer to generate a further daughter node, of the daughter node of the at least one node, in the higher second layer. In some embodiments, growing, from the at least one node, the plurality of layers of the neural network comprises dividing the at least one node to generate a daughter node, of the at least one node, in the higher second layer.

In some embodiments, the plurality of layers of the neural network comprises 2, 3, 4, 5, 6, 7, 8, 9, 10, 20, 30, 40, 50, 60, 70, 80, 90, 100, or more layers. In some embodiments, each of the plurality of layers of the neural network comprises 5, 10, 25, 50, 100, 250, 500, 1000, 2500, 5000, 10000, 25000, 50000, 100000, 250000, 500000, 1000000, or more nodes.

In some embodiments, an architecture of the lower first layer and higher second layer comprises a pooling architecture, and/or an architecture of two layers of the plurality of layers comprises a pooling architecture. In some embodiments, an architecture of the lower first layer and higher second layer comprises an expansion architecture, and/or an architecture of two layers of the plurality of layers comprises an expansion architecture. In some embodiments, the lower first layer and/or the higher second layer comprises a square geometry or a rectangular geometry. In some embodiments, the lower first layer and/or the higher second layer comprises a non-rectangular geometry. In some embodiments, the non-rectangular geometry comprises an annulus geometry, a spherical geometry, and/or disk geometry with a hyperbolic distribution. In some embodiments, the neural network comprises a spiking node. In some embodiments, the neural network comprises a spiking neural network.

In some embodiments, said growing is performed prior to said self-organizing. In some embodiments, said growing and said self-organizing are performed over a first plurality iterations. In some embodiments, said growing is performed prior to said self-organizing in each of the plurality of iterations. In some embodiments, said growing is performed over a first plurality of iterations followed by said self-organizing being performed over a second plurality iterations. In some embodiments, the first plurality of iterations and/or the second plurality of iterations comprises 5, 10, 25, 50, 100, 250, 500, 1000, 2500, 5000, 10000, 25000, 50000, 100000, 250000, 500000, 1000000, or more iterations.

In some embodiments, the method comprises generating the spatiotemporal waves based on noisy interactions between nodes of the first layer of the plurality of layers of the neural network. In some embodiments, said self-organizing comprises applying structural training data to the lower first layer. In some embodiments, the learning rule comprises a local learning rule. In some embodiments, the learning rule comprises a dynamic learning rule.

In some embodiments, the method comprises training a classifier connected to the plurality of layers and/or the neural network. In some embodiments, the method comprises: perform a task using the neural network. In some embodiments, the task comprises a computation processing task, an information processing task, a sensory input processing task, a storage task, a retrieval task, a decision task, an image recognition task, and/or a speech recognition task. In some embodiments, performing the task comprises performing an image recognition task on a plurality of images. In some embodiments, the plurality of images is captured by one or more edge cameras. In some embodiments, the plurality of images comprises a plurality of spherical images. In some embodiments, the plurality of spherical images is captured by one or more omnidirectional cameras.

In some embodiments, method comprises: further self-organize the plurality of layers of the neural network to update inter-layer connectivity between the lower first layer and the higher second layer, using spatiotemporal waves in a lower first layer of the plurality of layers of the neural network, and/or a learning rule implemented in a higher second layer of the plurality of layers of the neural network connected to the lower first layer of the plurality of layers of the neural network.

Disclosed herein include systems for constructing a neural network. In some embodiments, a system for constructing a neural network comprises: non-transitory memory configured to store executable instructions; and a hardware processor in communication with the non-transitory memory, the hardware processor programmed by the executable instructions to perform any method for constructing a neural network of the present disclosure. Disclosed herein include systems for performing a task using a neural network. In some embodiments, a system for constructing a neural network comprises: non-transitory memory configured to store executable instructions; and a hardware processor in communication with the non-transitory memory, the hardware processor programmed by the executable instructions to perform a task using a neural network constructed using any method of the present disclosure. Disclosed herein include devices for performing any method of the present disclosure. Disclosed herein include a computer readable medium comprising executable instructions that when executed by a hardware processor programs the hardware processor to perform any method of the present disclosure. Disclosed herein include a computer readable medium comprising codes representing a neural network constructed using any method of the present disclosure.

Details of one or more implementations of the subject matter described in this specification are set forth in the accompanying drawings and the description below. Other features, aspects, and advantages will become apparent from the description, the drawings, and the claims. Neither this summary nor the following detailed description purports to define or limit the scope of the inventive subject matter.

### BRIEF DESCRIPTION OF THE DRAWINGS

FIGS. 1A-1B: Wiring of the visual circuitry.

FIG. 2. Emergent spatiotemporal waves tile the first layer.

FIG. 3. Learning rule.

FIGS. 4A-4D. Self-organization of Pooling layers.

FIGS. 5A-5H. Features of the developmental algorithm.

FIGS. 6A-6D. Growing a layered neural network.

FIGS. 7A-7E. Networks grown from a single unit are functional.

FIGS. 8A-8B. Topology of sensor-node connections.

FIGS. 9A-9D. Growing a layered neural network.

FIG. 10. Growth flowchart.

FIG. 11. Sensor nodes arranged in a line.

FIG. 12. Strength of connections between sensor-nodes.

FIGS. 13-13C. Fixed points.

FIG. 14. Sensor nodes placed arbitrarily on a square plane.

FIGS. 15A-15C. Stable Fixed points.

FIGS. 16A-16D. Stable Fixed points.

FIGS. 17A-17D. Developmental algorithm scales efficiently to very large input layers.

FIGS. 18A-18B. Spontaneous waves in the developing brain.

FIGS. 19A-19D. Self-organizing multi-layer spiking neural networks.

FIGS. 20A-20B. Flexibility of the framework.

FIGS. 21A-21D. Unsupervised learning of self-organized networks.

FIGS. 22A-22B. Connectivity kernel of intra-layer connections.

FIG. 23. Spiking input x and response y of neurons across layers 2 & 3.

FIG. 24. Traveling waves in 3 layers.

FIG. 25. Inter-layer connectivity evolves over time.

FIGS. 26A-26D. Different wave regimes.

FIG. 27. The network self-organizing its connections.

FIG. 28. Sensor nodes arranged in a line.

FIG. 29. Strength of connections between sensor-nodes.

FIGS. 30A-30C. Fixed points.

FIGS. 31A-31D. Dynamics in phase space.

FIG. 32 is a block diagram of an illustrative computing system configured to implement any method of the present disclosure.

Throughout the drawings, reference numbers may be re-used to indicate correspondence between referenced elements. The drawings are provided to illustrate example embodiments described herein and are not intended to limit the scope of the disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein and made part of the disclosure herein.

All patents, published patent applications, other publications, and sequences from GenBank, and other databases referred to herein are incorporated by reference in their entirety with respect to the related technology.

### Neural Network Construction

Disclosed herein include methods for constructing a neural network. In some embodiments, a method for constructing a neural network is under control of a hardware processor and comprises: growing, from at least one node, a plurality of layers of a neural network each comprises a plurality of nodes. The method can comprise: self-organizing the plurality of layers of the neural network to alter inter-layer connectivity between the lower first layer and the higher second layer, using spatiotemporal waves in a lower first layer of the plurality of layers of the neural network, and/or a learning rule implemented in a higher second layer of the plurality of layers of the neural network connected to the lower first layer of the plurality of layers of the neural network. In some embodiments, the hardware processor comprises a neuromorphic processor.

In some embodiments, the at least one node comprises a single node. In some embodiments, growing, from the at least one node, the plurality of layers of the neural network comprises dividing the at least one node to generate a daughter node, of the at least one node, in the lower first layer. In some embodiments, the method comprises dividing the daughter node in the lower first layer to generate a further daughter node, of the daughter node of the at least one node, in the lower first layer. In some embodiments, the method comprises dividing the daughter node in the lower first layer to generate a further daughter node, of the daughter node of the at least one node, in the higher second layer. In some embodiments, growing, from the at least one node, the plurality of layers of the neural network comprises dividing the at least one node to generate a daughter node, of the at least one node, in the higher second layer.

In some embodiments, the plurality of layers of the neural network comprises 2, 3, 4, 5, 6, 7, 8, 9, 10, 20, 30, 40, 50, 60, 70, 80, 90, 100, or more layers. In some embodiments, each of the plurality of layers of the neural network comprises 5, 10, 25, 50, 100, 250, 500, 1000, 2500, 5000, 10000, 25000, 50000, 100000, 250000, 500000, 1000000, or more nodes.

In some embodiments, an architecture of the lower first layer and higher second layer comprises a pooling architecture, and/or an architecture of two layers of the plurality of layers comprises a pooling architecture. In some embodiments, an architecture of the lower first layer and higher second layer comprises an expansion architecture, and/or an architecture of two layers of the plurality of layers comprises an expansion architecture. In some embodiments, the lower first layer and/or the higher second layer comprises a square geometry or a rectangular geometry. In some embodiments, the lower first layer and/or the higher second layer comprises a non-rectangular geometry. In some embodiments, the non-rectangular geometry comprises an annulus geometry, a spherical geometry, and/or disk geometry with a hyperbolic distribution. In some embodiments, the neural network comprises a spiking node. In some embodiments, the neural network comprises a spiking neural network.

In some embodiments, said growing is performed prior to said self-organizing. In some embodiments, said growing and said self-organizing are performed over a first plurality iterations. In some embodiments, said growing is performed prior to said self-organizing in each of the plurality of iterations. In some embodiments, said growing is performed over a first plurality of iterations followed by said self-organizing being performed over a second plurality iterations. In some embodiments, the first plurality of iterations and/or the second plurality of iterations comprises 5, 10, 25, 50, 100, 250, 500, 1000, 2500, 5000, 10000, 25000, 50000, 100000, 250000, 500000, 1000000, or more iterations.

In some embodiments, the method comprises generating the spatiotemporal waves based on noisy interactions between nodes of the first layer of the plurality of layers of the neural network. In some embodiments, said self-organizing comprises applying structural training data to the lower first layer. In some embodiments, the learning rule comprises a local learning rule. In some embodiments, the learning rule comprises a dynamic learning rule.

In some embodiments, method comprises: further self-organize the plurality of layers of the neural network to update inter-layer connectivity between the lower first layer and the higher second layer, using spatiotemporal waves in a lower first layer of the plurality of layers of the neural network, and/or a learning rule implemented in a higher second layer of the plurality of layers of the neural network connected to the lower first layer of the plurality of layers of the neural network.

### Neural Network Application

In some embodiments, the method comprises training a classifier connected to the plurality of layers and/or the neural network. In some embodiments, the method comprises: perform a task using the neural network. In some embodiments, the task comprises a computation processing task, an information processing task, a sensory input processing task, a storage task, a retrieval task, a decision task, an image recognition task, and/or a speech recognition task. In some embodiments, performing the task comprises performing an image recognition task on a plurality of images. In some embodiments, the plurality of images is captured by one or more edge cameras. In some embodiments, the plurality of images comprises a plurality of spherical images. In some embodiments, the plurality of spherical images is captured by one or more omnidirectional cameras.

### EXAMPLES

Some aspects of the embodiments discussed above are disclosed in further detail in the following examples, which are not in any way intended to limit the scope of the present disclosure.

### Example 1

### Neural Networks Grown and Self-Organized by Noise

Living neural networks emerge through a process of growth and self-organization that begins with a single cell and results in a brain, an organized and functional computational device. Artificial neural networks, however, rely on human-designed, hand-programmed architectures for their remarkable performance. This example describes a biologically inspired developmental algorithm that can ‘grow’ a functional, layered neural network from a single initial cell. The algorithm organizes inter-layer connections to construct retinotopic pooling layers. The approach is inspired by the mechanisms employed by the early visual system to wire the retina to the lateral geniculate nucleus (LGN), days before animals open their eyes. The key ingredients for robust self-organization are an emergent spontaneous spatiotemporal activity wave in the first layer and a local learning rule in the second layer that ‘learns’ the underlying activity pattern in the first layer. The algorithm is adaptable to a wide-range of input-layer geometries, robust to malfunctioning units in the first layer, and so can be used to successfully grow and self-organize pooling architectures of different pool-sizes and shapes. The algorithm provides a procedure for constructing layered neural networks through growth and self-organization. This example also demonstrates that networks grown from a single unit perform as well as hand-crafted networks on MNIST. Broadly, this example shows that biologically inspired developmental algorithms can be applied to autonomously grow functional ‘brains’ in-silico.

### 1 Introduction

Living neural networks in the brain perform an array of computational and information processing tasks including sensory input processing, storing and retrieving memory, decision making, and more globally, generate the general phenomena of “intelligence”. In addition to their information processing feats, brains are unique because they are computational devices that actually self-organize their intelligence. In fact brains ultimately grow from single cells during development. Engineering has yet to construct artificial computational systems that can self-organize their intelligence. This example, inspired by neural development, is a step towards artificial computational devices building (including growing and self-organizing) themselves without human intervention.

Deep neural networks (DNNs) are one of the most powerful paradigms in Artificial Intelligence. Deep neural networks have demonstrated human-like performance in tasks ranging from image and speech recognition to game-playing. Although the layered architecture plays an important role in the success of deep neural networks, the widely accepted state of art is to use a hand-programmed network architecture or to tune multiple architectural parameters, both requiring significant engineering investment. Convolutional neural networks, a specific class of DNNs, employ a hand programmed architecture that mimics the pooling topology of neural networks in the human visual system.

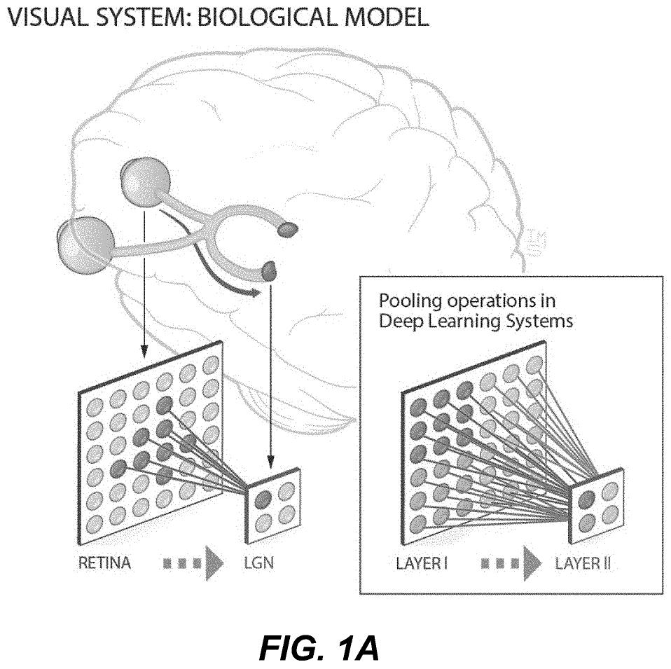

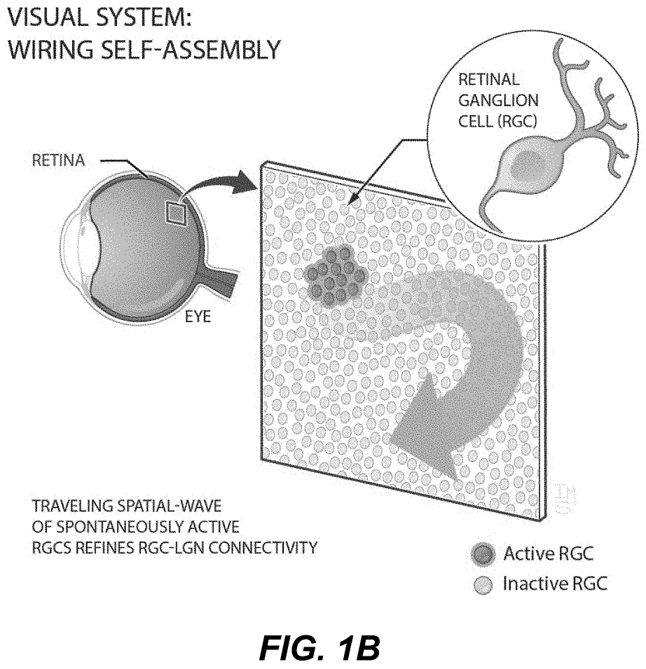

This example develops strategies for growing a neural network autonomously from a single computational “cell” followed by self-organization of its architecture by implementing a wiring algorithm inspired by the development of the mammalian visual system. The visual circuitry, specifically the wiring of the retina to the lateral geniculate nucleus (LGN) is stereotypic across organisms, as the architecture always enforces pooling (retinal ganglion cells (RGC's) pool their inputs to LGN cells) and retinotopy. The pooling architecture (FIG. 1A) is robustly established early in development through the emergence of spontaneous activity waves (FIG. 1B) that tile the light insensitive retina. As the synaptic connectivity between the different layers in the visual system get tuned in an activity-dependent manner, the emergent activity waves serve as a signal to alter inter-layer connectivity much before the onset of vision.

FIGS. 1A-1B: Wiring of the visual circuitry. FIG. 1A. Spatial pooling observed in wiring from the retina to LGN and in CNN's. FIG. 1B Synchronous Spontaneous bursts (retinal waves) in the light-insensitive retina serve as a signal for wiring retina to the brain.

This example provides a developmental algorithm inspired by visual system development to grow and self-organize a retinotopic pooling architecture, similar to modern convolutional neural networks (CNNs). Once a pooling architecture emerges, any non-linear function can be implemented by units in the second layer to morph it into functioning as a convolution or a max/average pooling. This example shows that the algorithm is adaptable to a wide-range of input-layer geometries and is robust to malfunctioning units, for example, in the first layer. The algorithm can grow pooling architectures of different shapes and sizes and is capable of countering the key challenges accompanying growth. This example also demonstrates that ‘grown’ networks are functionally similar to that of hand-programmed pooling networks, on conventional image classification tasks. As CNN's represent a model class of deep networks, the developmental strategy described herein can be broadly implemented for the self-organization of intelligent systems.

### 2 Related Work

Computational models for self-organizing neural networks dates back many years, with the first demonstration being Fukushima's neocognitron, a hierarchical multi-layered neural network capable of visual pattern recognition through learning. Although weights connecting different layers were modified in an unsupervised fashion, the network architecture was hard-coded, inspired by Hubel and Wiesel's description of simple and complex cells in the visual cortex. Fukushima's neocognitron inspired modern-day convolutional neural networks (CNN). Although CNNs performed well on image-based tasks, the CNNs had a fixed, hand-designed architecture whose weights were altered by back-propagation. The use of a fixed, hand-designed architecture for a neural network changed with the advent of neural architecture search, as neural architectures became malleable to tuning by neuro-evolution strategies, reinforcement learning, and multi-objective searches. Neuro-evolution strategies have been successful in training networks that perform significantly much better on CIFAR-10, CIFAR-100 and Image-Net datasets. As the objective function being maximized is the predictive performance on a single dataset, the evolved networks may not generalize well to multiple datasets. On the contrary, biological neural networks in the brain grow architecture that can generalize very well to innumerable datasets. Neuroscientists have been very interested in how the architecture in the visual cortex emerges during brain development. Spontaneous and spatially organized synchronized bursts prevalent in the developing retina have been suggested to guide the self-organization of cortical receptive fields. In this light, mathematical models of the retina and its emergent retinal waves were built, and analytical solutions were obtained regarding the self-organization of wiring between the retina and the LGN. Computational models have been essential for understanding how self-organization functions in the brain, but have not been generalized to growing complex architectures that can compute. One of the most successful attempts at growing a 3D model of neural tissue from simple precursor units was demonstrated that defined a set of minimal rules that could result in the growth of morphologically diverse neurons. Although the networks were grown from single units, the networks were not functional as the networks were not equipped to perform any task. To bridge this gap, this example illustrates growing and self-organizing functional neural networks from a single precursor unit.

### 3 Bio-Inspired Developmental Algorithm

In the procedure of this example, the pooling architecture emerges through two processes, growth of a layered neural network followed by self-organization of its inter-layer connections to form defined ‘pools’ or receptive fields. The emphasis in the next few sections is on the self-organization process, following by the growth of a layered neural network with its self-organization in the penultimate section of this example.

First, the natural development strategy is abstracted as a mathematical model around a set of input sensor nodes in the first layer (similar to retinal ganglion cells) and processing units in the second layer (similar to cells in the LGN).

Self-organization comprises of two major elements: (1) A spatiotemporal wave generator in the first layer driven by noisy interactions between input-sensor nodes and (2) A local learning rule implemented by units in the second layer to learn the “underlying” pattern of activity generated in the first layer. The two elements are inspired by mechanisms deployed by the early visual system. The retina generates spontaneous activity waves that tile the light-insensitive retina; the activity waves serve as input signals to wire the retina to higher visual areas in the brain.

### 3.1 Spontaneous Spatiotemporal Wave Generator

The first layer of the network can serve as a noise-driven spatiotemporal wave generator when (1) its constituent sensor-nodes are modeled via an appropriate dynamical system and (2) when these nodes are connected in a suitable topology. In this example, each sensor node is modeled using the classic Izikhevich neuron model (dynamical system model), while the input layer topology is that of local-excitation and global-inhibition, a motif that is ubiquitous across various biological systems. A minimal dynamical systems model coupled with the local-excitation and global-inhibition motif has been analytically examined in the Supplemental Materials section of this example to demonstrate that these key ingredients are sufficient to serve as a spatiotemporal wave generator.

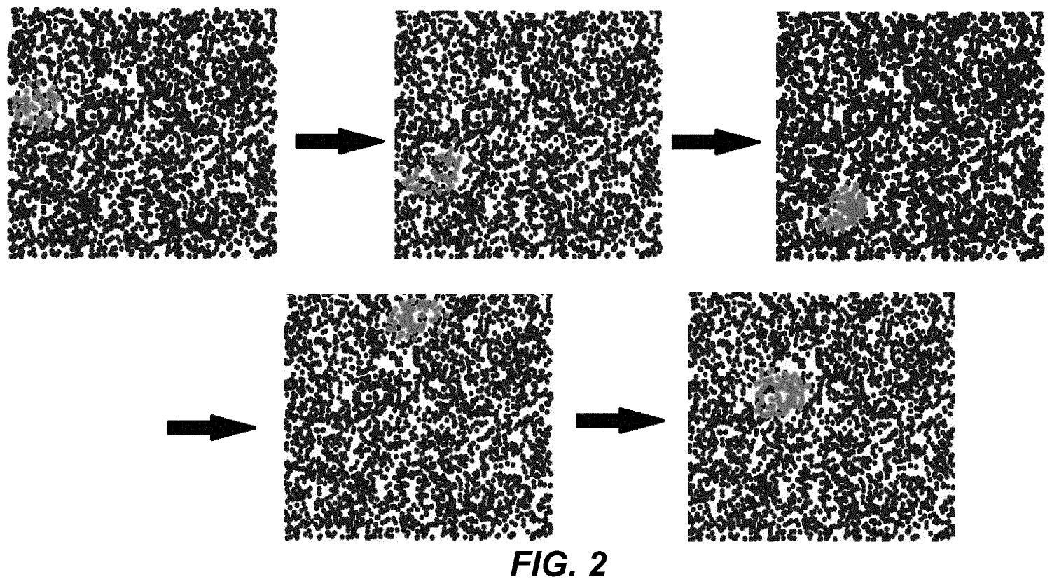

FIG. 2. Emergent spatiotemporal waves tile the first layer. The red-nodes indicate active-nodes (firing), black nodes refer to silent nodes and the arrows denote the direction of time.

The Izhikevich model captures the activity of every sensor node (vᵢ(t)) through time, the noisy behavior of individual nodes (through ηᵢ(t)) and accounts for interactions between nodes defined by a synaptic adjacency matrix (S_{i,j}). The Izhikevich model equations are elaborated in section 3.1.1 in this example. The input layer topology (local excitation, global inhibition) is defined by the synaptic adjacency matrix (S_{i,j}). Every node in the first layer makes excitatory connections with nodes within a defined local excitation radius. S_{i,j}=5, when distance between nodes i and j are within the defined excitation radius of 2 units; dᵢⱼ≤2. Each node has decaying inhibitory connections with other nodes present above a defined global inhibition radius (S_{i,j}=−2 exp(−dᵢⱼ/10), when distance between nodes i and j are above a defined inhibition radius of 4 units; dᵢⱼ≥4) (see the Supplemental Materials section of this example).

On implementing a model of the resulting dynamical system, the emergence of spontaneous spatiotemporal waves that tile the first layer for specific parameter regimes is observed (see FIG. 2).

### 3.1.1 Dynamical Model for Input-Sensor Nodes in the Lower Layer (Layer-I)

$$\frac{d {v}_{i}}{d t} = 0.04 {v}_{i}^{2} + 5 {v}_{i} + 140 - {u}_{i} + {\sum }_{j = 1}^{N} {S}_{i , j} ℋ ( {v}_{j} - 30 ) + {η}_{i} ( t )$$

$$\frac{d {u}_{i}}{d t} = {a}_{i} ( {b}_{i} {v}_{i} - {u}_{i} )$$

with the auxiliary after-spike reset:

$${v}_{i} ( t ) > 30 , then : \{ \begin{matrix}{v}_{i} ( t + Δ t ) = {c}_{i} \\ {u}_{i} ( t + Δ t ) = {u}_{i} ( t ) + {d}_{i}\end{matrix}$$

where: (1) vᵢ is the activity of sensor node i; (2) u₁ captures the recovery of sensor node i; (3) Sᵢⱼ is the connection weight between sensor-nodes i and j; (4) N is the number of sensor-nodes in layer-I; (5) Parameters aᵢ and bᵢ are set to 0.02 and 0.2 respectively, while cᵢ and dᵢ are sampled from the distributions [symbol] (−65, −50) and [symbol] (2,8) respectively. Once set for every node, the parameters remain constant during the process of self-organization. The initial values for vᵢ (0) and uᵢ(0) are set to −65 and −13 respectively for all nodes; (6) ηᵢ(t) models the noisy behavior of every node i in the system, where <ηᵢ(t)ηⱼ(t′)>=σ² δ_{i,j}δ(t−t′). Here, δ_{i,j}, δ(t−t′) are Kronecker-delta and Dirac-delta functions respectively, and σ²=9; (7) [symbol] is the unit step function:

$$ℋ ( {v}_{i} - 30 ) = \{ \begin{matrix}1 , & {v}_{i} \geq 30 \\ 0 , & {v}_{i} < 30 .\end{matrix}$$

### 3.2 Local Learning Rule

Having constructed a spontaneous spatiotemporal wave generator in layer-I, the algorithm implements a local learning rule in layer-II that can learn the activity wave pattern in the first layer and modify its inter-layer connections to generate a pooling architecture. Many neuron inspired learning rules can learn a sparse code from a set of input examples. Here, processing units are modeled as rectified linear units (ReLU) and a modified Hebbian rule is modeled for tuning the inter-layer weights to achieve the same. Individual ReLU units compete with one another in a winner take all fashion.

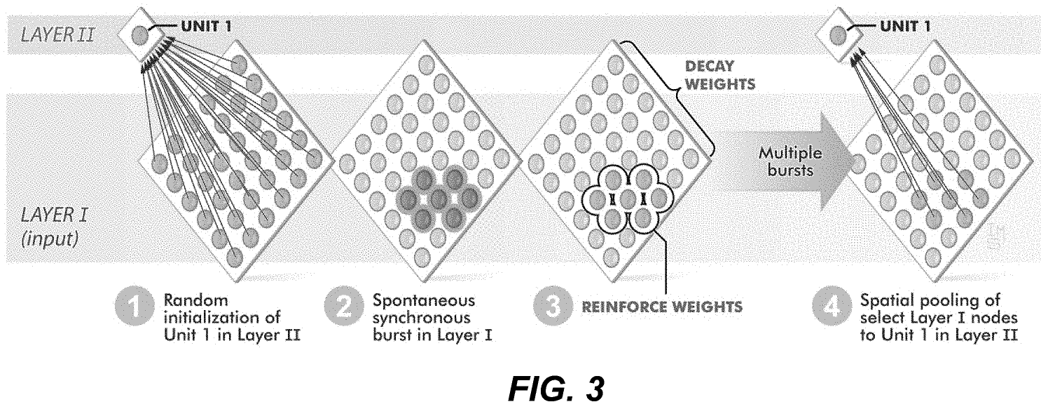

Initially, every processing unit in the second layer is connected to all input-sensor nodes in the first layer. As the emergent activity wave tiles the first layer, at most a single processing unit in the second layer is activated due to the winner-take-all competition. The weights connecting the activated unit in the second layer to the input-sensor nodes in the first layer are updated by the modified Hebbian rule (section 3.2.1). Weights connecting active input-sensor nodes and activated processing units are reinforced while weights connecting inactive input-sensor nodes and activated processing units decay (cells that fire together, wire together). Inter-layer weights are updated continuously throughout the self-organization process, ultimately resulting in the pooling architecture (See FIG. 3 and the Supplemental Materials section of this example).

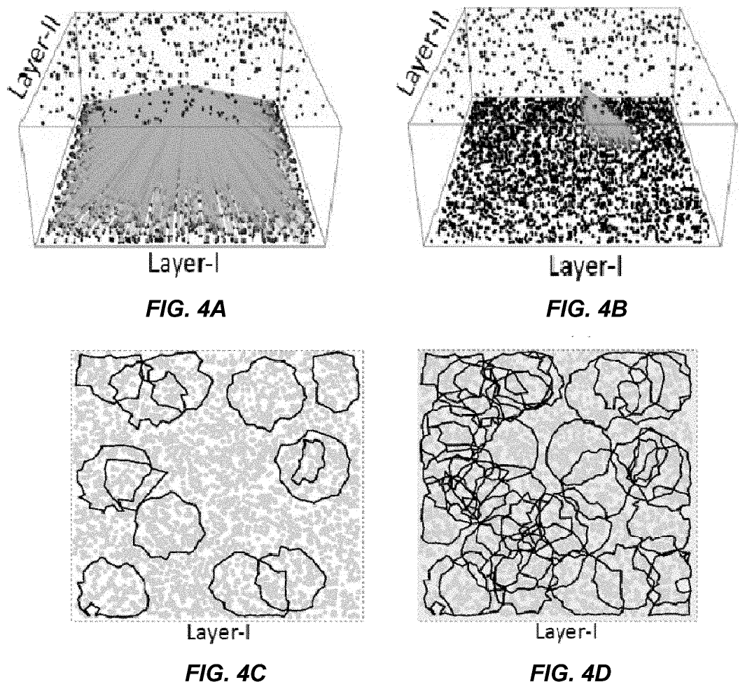

Having coupled the spontaneous spatiotemporal wave generator and the local learning rule, an observation is that an initially fully connected two-layer network (FIG. 4A) becomes a pooling architecture, wherein input-sensor nodes that are in close proximity to each other in the first layer have a very high probability of connecting to the same processing unit in the second layer (FIGS. 4B and 4C). More than 95% of the sensor-nodes in layer-I connect to processing units in layer-II (higher layer) through well-defined pools, ensuring that spatial patches of nodes connected to units in layer-II tile the input layer (FIG. 4D). Tiling the input layer ensures that most sensor nodes have an established means of sending information to higher layers after the self-organization of the pooling layer.

FIGS. 4A-4D. Self-organization of Pooling layers. FIG. 4A. The initial configuration, wherein all nodes in the lower layer are connected to every unit in the higher layer. FIG. 4B. After the self-organization process, a pooling architecture emerges, wherein every unit in layer-II is connected to a spatial patch of nodes in layer-I. In FIGS. 4A-4B, connections from nodes in layer-I to a single unit in layer-II (higher layer) are shown. FIG. 4C. Each contour represents a spatial patch of nodes in layer-I connected to a single unit in layer-II. FIG. 4D. More than 95% of the nodes in layer-I are connected to units in the layer-II through well-defined pools, as the spatial patches tile layer-I completely.

### 3.2.1 Modifying Inter-Layer Weights

$${w}_{i , j} ( t + 1 ) = \{ \begin{matrix}{w}_{i , j} ( t ) + {η}_{learn} ℋ ( {v}_{i} ( t ) - 30 ) {y}_{j} ( t + 1 ) , & {y}_{j} ( t + 1 ) > 0 \\ {w}_{i , j} ( t ) , & otherwise\end{matrix}$$

where: (1) w_{i,j}(t) is the weight of connection between sensor-node i and processing unit j at time ‘t’ (inter-layer connection); (2) ηₗₑₐᵣₙ is the learning rate; (3) [symbol] (vᵢ(t)−30) is the activity of sensor node i at time ‘t’; and (4) yⱼ(t) is the activation of processing unit j at time ‘t’.

Once all the weights w_{i,j}(t+1) have been evaluated for a processing unit j, the weights are mean-normalized to prevent a weight blow-up. Mean normalization ensures that the mean strength of weights for processing unit j remains constant during the self-organization process.

### 4 Features of the Developmental Algorithm

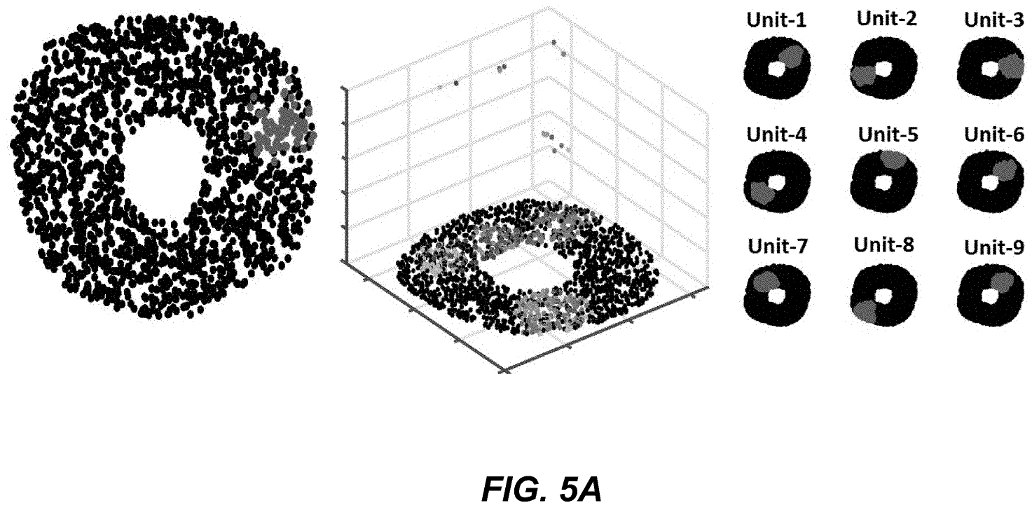

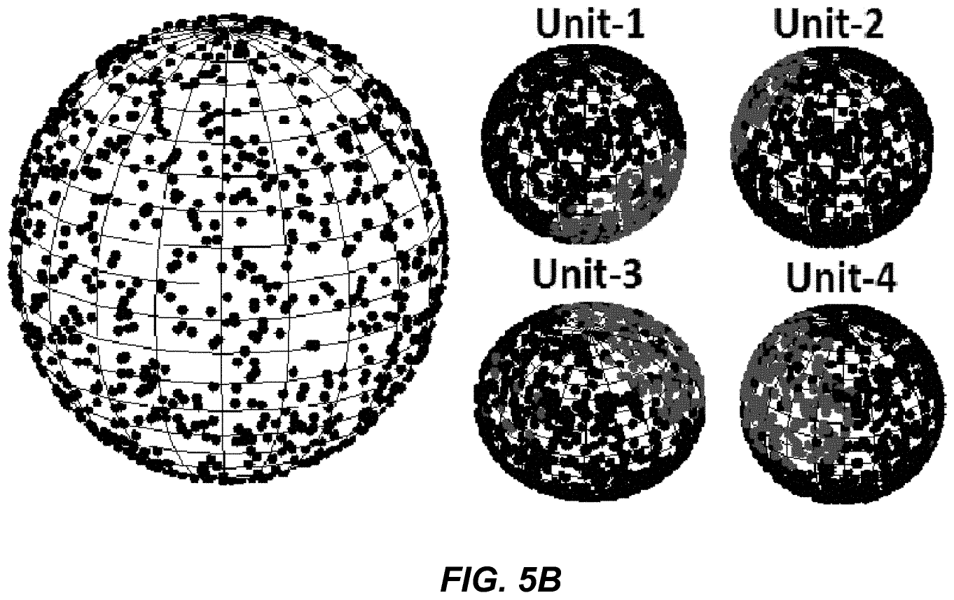

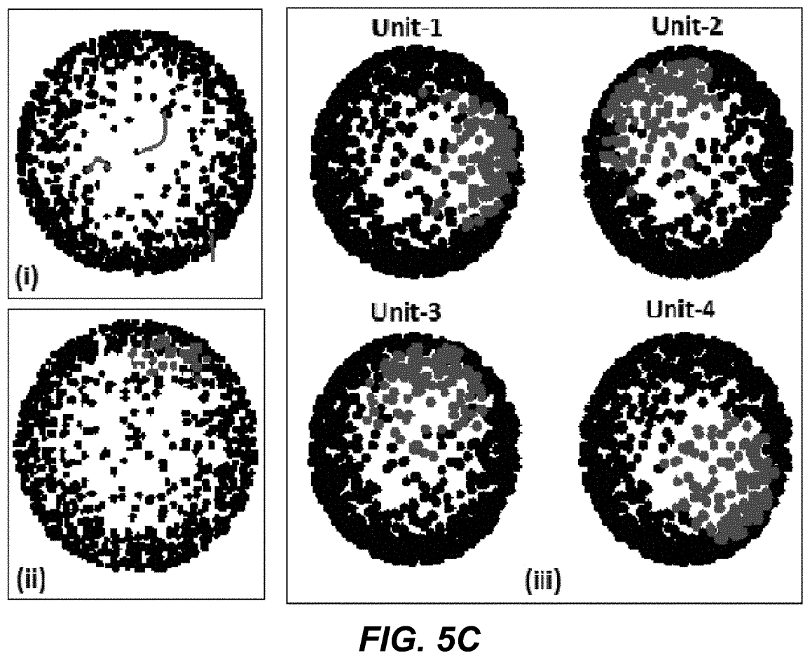

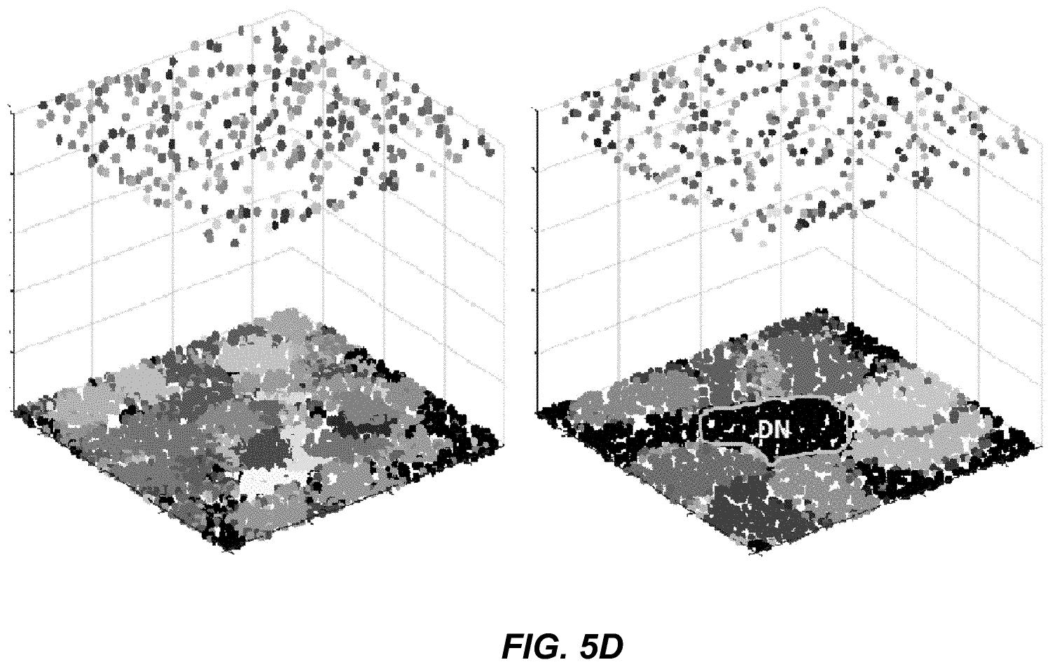

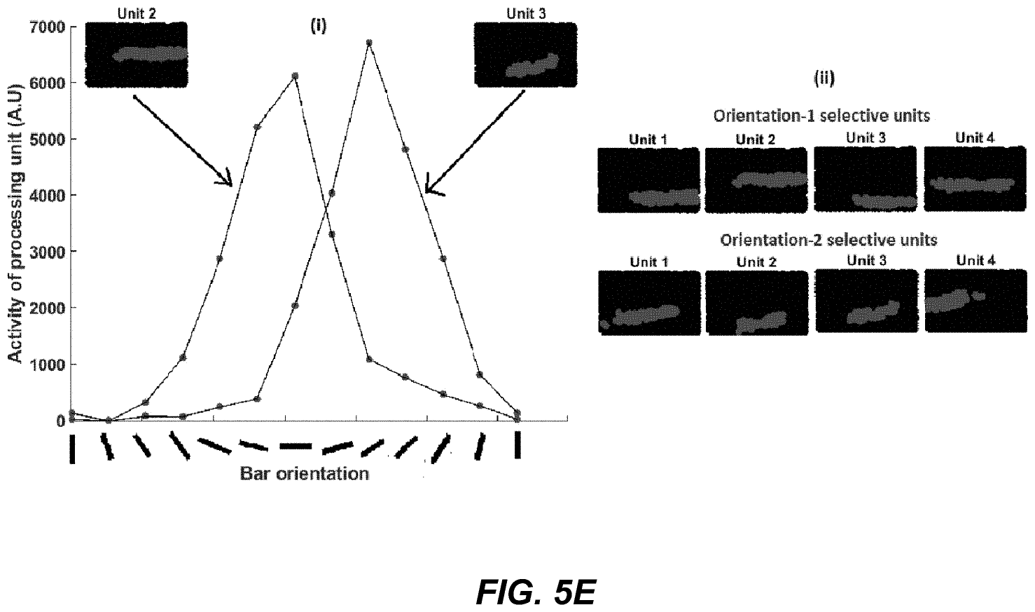

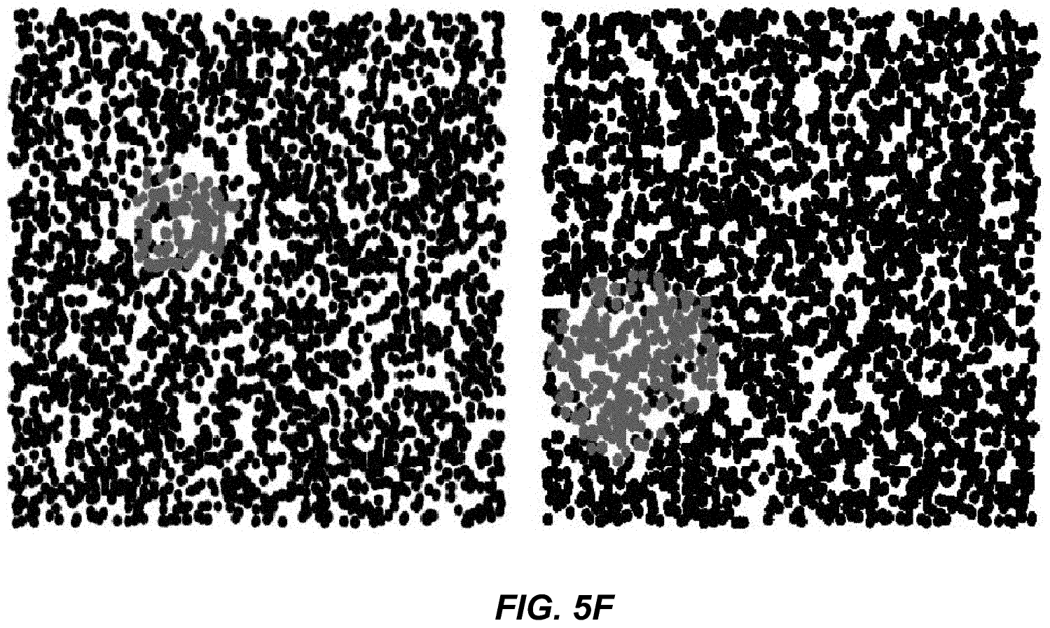

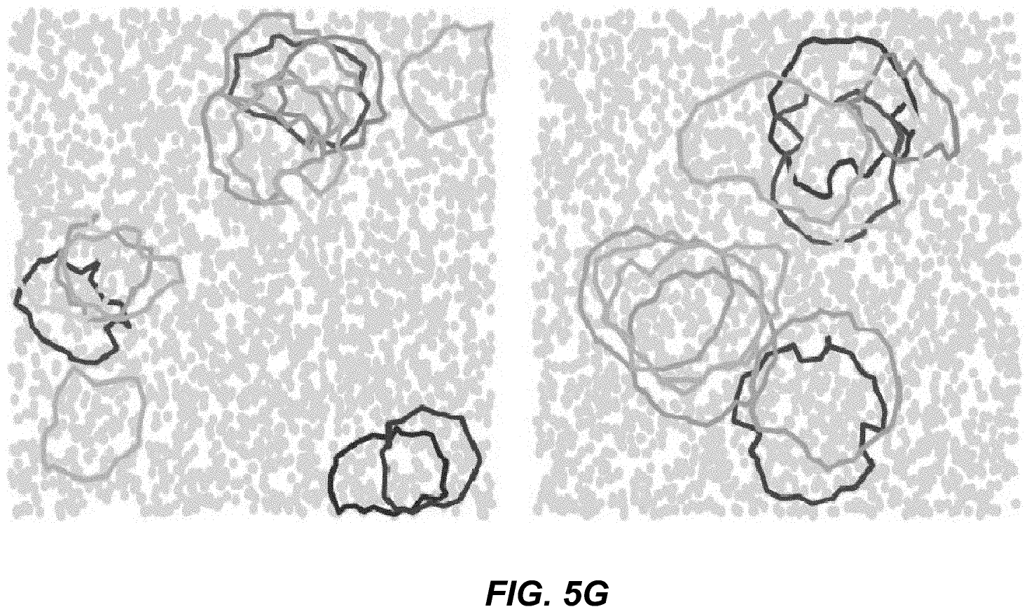

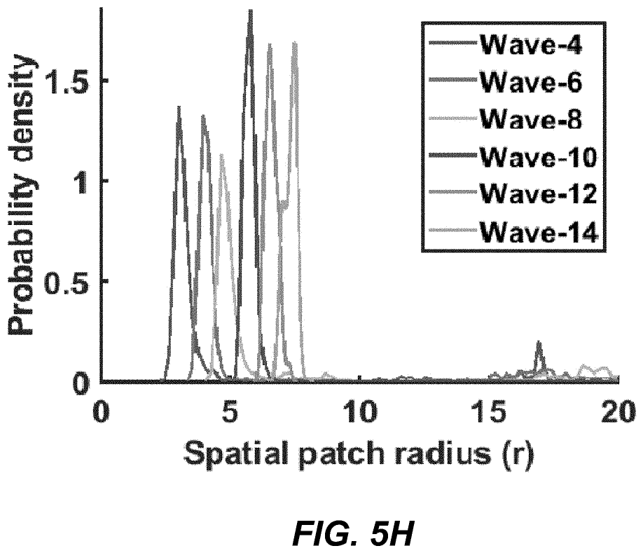

This section shows that spatiotemporal waves can emerge and travel over layers with arbitrary geometries and even in the presence of defective sensor-nodes. As the local structure of sensor-node connectivity (local excitation and global inhibition) in the input layer in conserved over a broad range of macroscale geometries (FIGS. 5A-5H), traveling activity waves in input layers with arbitrary geometries and in input-layers that have defects or holes are observed. The coupling of the traveling activity wave in layer-I and a learning rule in layer-II results in the emergence of pooling architecture (refer to the Supplementary Materials for an analytical treatment).

Furthermore, this example demonstrates that the size and shape of the emergent spatiotemporal wave can be tuned by altering the topology of sensor-nodes in the layer. Coupling the emergent wave in layer-I with a learning rule in layer-II leads to localized receptive fields that tile the input layer.

Together, the wave and the learning rule endow the developmental algorithm with useful properties. (i) Flexibility: Spatial patches of sensor-nodes connected to units in layer-II can be established over arbitrary input-layer geometries. FIG. 5A shows that an emergent spatiotemporal wave on a torus-shaped input layer coupled with the local learning rule (section 3.2) in layer-II, results in a pooling architecture. FIG. 5B shows that the developmental algorithm can self-organize networks on arbitrary curved surfaces. Flexibility to form pooling layers on arbitrary input-layer geometries is useful for processing data acquired from unconventional sensors, like charge-coupled devices that mimic the retina. The ability to self-organize pooling layers on curved surfaces makes the algorithm extremely useful for spherical image analysis. Spherical images acquired by omnidirectional cameras placed on drones are becoming increasingly ubiquitous, and their analysis necessitates neural networks that can tile 3-dimensional surfaces. (ii) Robustness: Spatial patches of sensor-nodes connected to units in layer-II can be established in the presence of defective sensor nodes in layer-I. As shown in FIG. 5B, the algorithm initially self-organizes a pooling architecture for a fully functioning set of sensor-nodes in the input-layer. To test robustness, a few sensor-nodes in the input-layer are ablated (captioned ‘DN’). Following this perturbation, the pooling architecture re-emerges, wherein spatial-pools of sensor-nodes, barring the damaged ones, re-form and connect to units in layer-II. (iii) Reconfigurable: The size and shape of spatial pools generated can be modulated by tuning the structure of the emergent traveling wave (FIGS. 5C and 5D). FIG. 5E shows that the size of spatial-pools can be altered in a controlled manner by modifying the topology of layer-I nodes. Wave-x in the legend corresponds to an emergent wave generated in layer-I when every node in layer-I makes excitatory connections to other nodes in its 2-unit radius and inhibitory connections to every node above x-unit radius. This topological change alters the properties of the emergent wave, subsequently changing the resultant spatial-pool size. The histograms corresponding to these legends capture the distribution of spatial-pool sizes over all pools generated by a given wave-x. The histogram also highlights that the size of emergent spatial-pools are tightly regulated for every wave-configuration.

FIGS. 5A-5H. Features of the developmental algorithm. FIG. 5A. Self-organization of pooling layers for arbitrary input-layer geometry. The left most image is a snapshot of the traveling wave as it traverses layer-I; Layer-I has sensor-nodes arranged in an annulus geometry; red nodes refer to firing nodes. On coupling the spatiotemporal wave in layer-I to a learning rule in layer-II, a pooling architecture emerges. The central image refers to the 3D visualization of the pooling architecture, while each subplot in the right-most image depicts the spatial patch of nodes in layer-I connected to a single processing unit in layer-II. FIG. 5B. Self-organizing pooling layers on a sphere. The right image shows upstream units connect to spatial patches of nodes on the sphere. FIG. 5C. Self-organizing networks on Poincare disks with a hyperbolic distribution of input sensor nodes FIG. 5C panel ii. Snapshot of a traveling bump. FIG. 5C panel iii. Receptive fields of units in layer-II. FIG. 5D. Self-organization of pooling layers are robust to input layer defects. The figure on the left depicts a self-organized pooling layer when all input nodes are functioning. Once these inter-layer connections are established, a small subset of nodes are damaged to assess if the pooling architecture can robustly re-form. The set of nodes within the grey boundary, titled ‘DN’, are defective nodes. The figure on the right corresponds to pooling layers that have adapted to the defects in the input layer, hence not receiving any input from the defective nodes. FIG. 5E panel i. Tuning curve shows that units in layer-II have a preferred orientation. FIG. 5E panel ii. Oriented receptive fields of units in layer-II. FIGS. 5F-5H. Pooling layers are reconfigurable. FIG. 5F. By altering layer-I topology (excitation/inhibition radii), the algorithm can tune the size of the emergent spatial wave. The size of the wave is 6 A.U (left) and 10 A.U (right). FIG. 5G. Altering the size of the emergent spatial wave tunes the emergent pooling architecture. The size of the pools obtained are 4 A.U (left), obtained from a wave-size of 6 A.U and a pool-size of 7 A.U (right), obtained from a wave-size of 10 A.U. FIG. 5H. A large set of spatial-pools are generated for every size-configuration of the emergent wave. The distribution of spatial-pool sizes over all pools generated by a specific wave-size are captured by a kernel-smoothed histogram. Wave-4 in the legend corresponds to a histogram of pool-sizes generated by an emergent wave of size 4 A.U (blue line). Spatial patches that emerge for every configuration of the wave have a tightly regulated size.

### 5 Growing a Neural Network

As the developmental algorithm (introduced in section 3) is flexible to varying scaffold geometries and tolerant to malfunctioning nodes, the algorithm can be implemented for growing a system, enabling us to push AI in the direction towards being more ‘life-like’ by reducing human involvement in the design of complex functioning architectures. The growth paradigm implemented in this section has been inspired by mechanisms that regulate neocortical development.

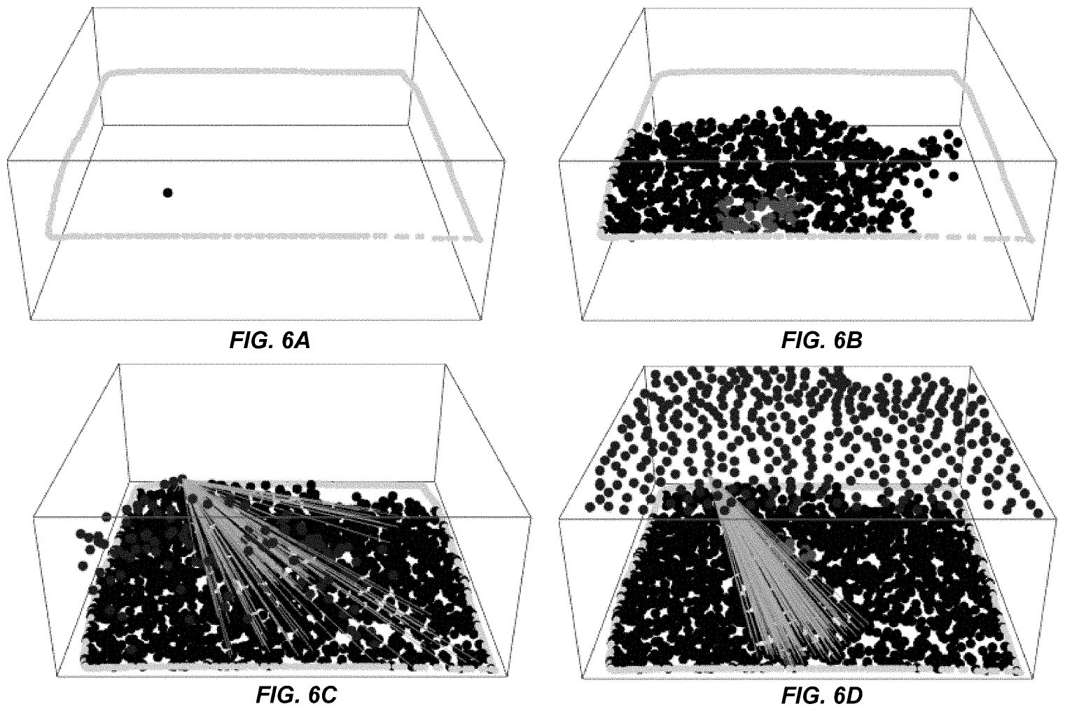

The process of growing a layered neural network involves two major sub-processes. One, every ‘node’ can divide horizontally to produce daughter nodes that populates the same layer; two, every node can divide vertically to produce daughter processing units that migrate upwards to populate higher layers. Division is stochastic and is controlled by a set of random variables. Having defined the 3D scaffold, seed a single unit is seeded (FIG. 6A). As horizontal and vertical division ensues to form the layered neural network, inter-layer connections are modified based on the emergent activity wave in layer-I and a learning rule (section 3.2) in layer-II, to form a pooling architecture. A detailed description of the growth rule-set coupled with a flow chart governing the growth of the network is appended to the Supplemental Materials section of this example.

FIGS. 6A-6D. Growing a layered neural network. FIG. 6A. A single computational “cell” (black node) is seeded in a scaffold defined by the grey boundary. FIG. 6B. Once this “cell” divides, daughter cells make local-excitatory and global-inhibitory connections. As the division process continues, noisy interactions between nodes results in emergent spatiotemporal waves (red nodes). FIG. 6C. Some nodes within layer-I divide to produce daughter cells that migrate upwards to form processing units (blue nodes). The connections between the two layers are captured by the lines that connect a single unit in a higher layer to nodes in the first layer (Only connections from a single unit are shown). FIG. 6D. After a long duration, the system reaches a steady state, where two layers have been created with an emergent pooling architecture.

Having intertwined the growth of the system and self-organization of inter-layer connections, the following observations can be made: (1) spatiotemporal waves emerge in the first layer much before the entire layer is populated (FIG. 6B), (2) self-organization of inter-layer connections commences before the layered network is fully constructed (FIG. 6C), and (3) over time, the system reaches a steady state as the number of ‘cells’ in the layered network remains constant and most processing units in the second layer connect to a pool of nodes in the first layer, resulting in the pooling architecture (FIG. 6D).

### 6 Growing Functional Neural Networks

The previous section demonstrates that multi-layered pooling networks can be successfully grown from a single unit. This section shows that these networks are functional.

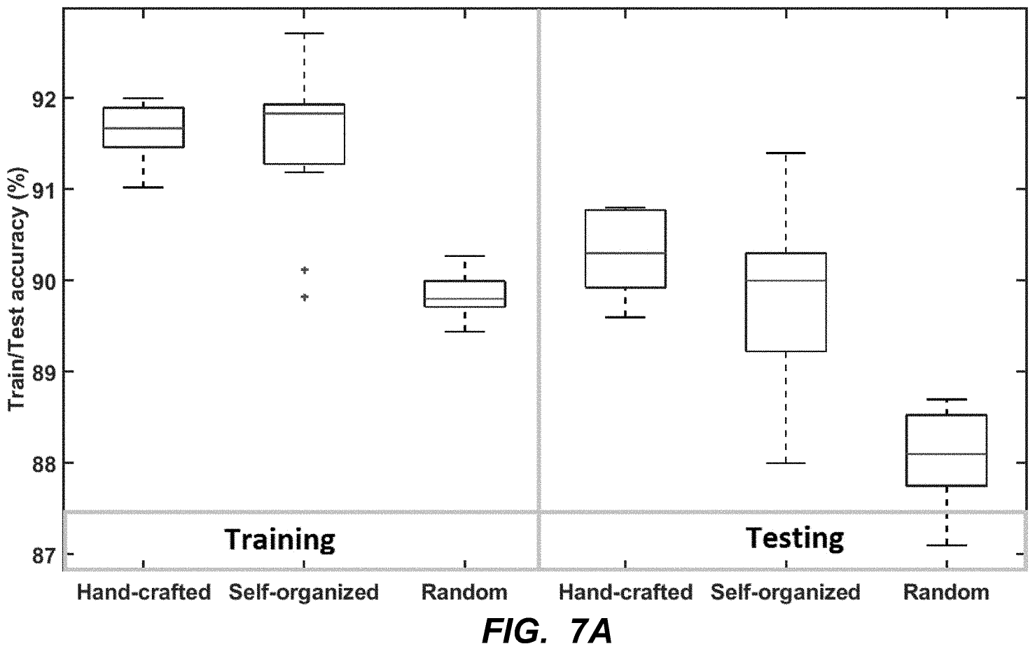

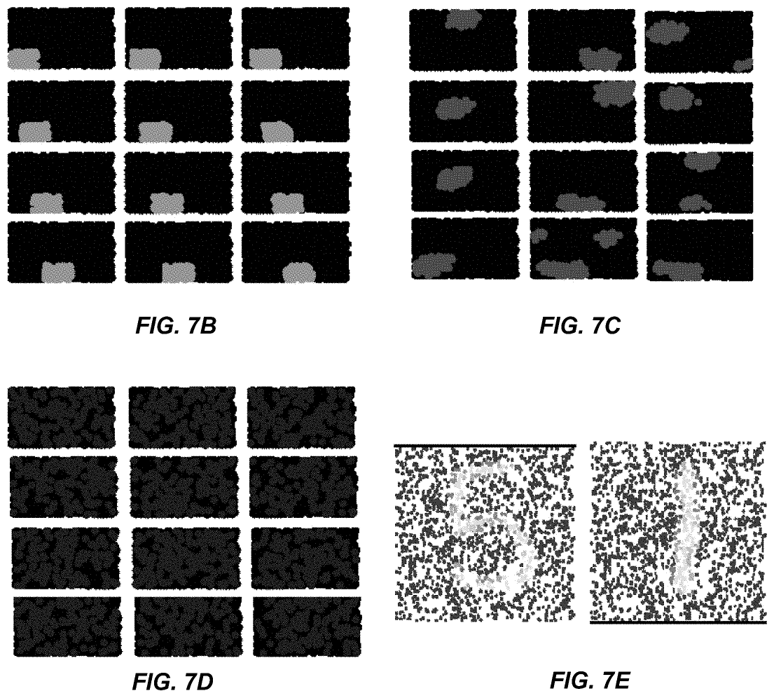

This section demonstrates functionality of networks grown and self-organized from a single unit (FIG. 7C) by evaluating their train and test accuracy on a classification task. Here, networks are trained to classify images of handwritten digits obtained from the MNIST dataset (FIG. 7E). To interpret the results, the train/test accuracy of the hand-crafted pooling networks, self-organized networks, and random networks. Hand-crafted pooling networks have a user-defined pool size for all units in layer-II (FIG. 7B), while random networks have units in layer-II that connect to a random set of nodes in layer-I without any spatial bias (FIG. 7D), effectively not forming a pooling layer.

To test functionality of these networks, the two-layered network is coupled with a linear classifier that is trained to classify hand-written digits from MNIST on the basis of the representation provided by these three architectures (hand-crafted, self-organized and random networks). Self-organized networks classify with a 90% test accuracy, are statistically similar to hand-crafted pooling networks (90.5%, p-value=0.1591) and are statistically better than random networks (88%, p-value=5.6×10⁻⁵) (FIG. 7A). Performance is consistent over multiple self-organized networks. These results demonstrate that self-organized neural networks are functional and can be adapted to perform conventional machine-learning tasks, with the additional advantage of being autonomously grown from a single unit.

FIGS. 7A-7E. Networks grown from a single unit are functional. Three kinds of networks are trained and tested on images obtained from the MNIST database. 10000 training samples and 1000 testing samples are used. The 3 kinds of networks are: (i) Hand-crafted, (ii) Self-organized networks and (iii) random networks. The training procedure is run over n=11 networks to ensure that the developmental algorithm always produces functional networks. FIG. 7A. The box-plot captures the training and testing accuracy of these 3 networks. The testing accuracy of self-organized networks is comparable to that of hand-crafted networks (p-value=0.1591>0.05) and are much better than random networks (p-value=5.6×10⁻⁵). FIGS. 7A-7D. Each unit in the second layer is connected to a set of nodes in the lower layer. The set it is connected to are defined by the green, red or blue nodes in the subplots shown. FIG. 7B. Hand-crafted. FIG. 7C. Self-organized. FIG. 7D. Random-basis. FIG. 7E Two MNIST images as seen in the first layer.

### 7 Discussion

This example addresses a pertinent question of how artificial computational machines could be built autonomously with limited human intervention. Currently, architectures of most artificial systems are obtained through heuristics and hours of painstaking parameter tweaking. Inspired by the development of the brain, a developmental algorithm that enables the robust growth and self-organization of functional layered neural networks is implemented.

Implementation of the growth and self-organization framework brought many crucial questions concerning neural development. Neural development is classically defined and abstracted as occurring through discrete steps, one proceeding the other. However in reality, development is a continuous flow of events with multiple intertwined processes. In this example on growing artificial systems, the mixing of processes that control growth of nodes and self-organization of connections between nodes is observed. Timing can be controlled when processes of growth and connection occur in parallel.

The example also reinforces the significance of brain-inspired mechanisms for initializing functional architecture to achieve generalization for multiple tasks. A peculiar instance in the animal kingdom is the presence of precocial species, animals whose young are functional immediately after they are born (examples include domestic chickens, horses). One mechanism that enables functionality immediately after birth is spontaneous activity that assists in maturing neural circuits much before the animal receives any sensory input. This example shows how a layered architecture (mini-cortex) can emerge through spontaneous activity, multiple components of the brain can be grown, namely a hippocampus and a cerebellum, followed by wiring these regions in a manner useful for an organism's functioning. This paradigm of growing mini-brains in-silico can (i) allow exploring how different components in a biological brain interact with one another and guide design of neuroscience experiments and (ii) result in systems that can autonomously grow, function and interact with the environment in a more ‘life-like’ manner.

### Supplemental Materials

### 8 Mathematical Model

### 8.1 Dynamical Model for Input Sensor Nodes

Input sensor nodes are modeled using the Izhikevich neuron model. Izhikevich model has the least number of parameters for accurately modeling neuron-like activity and the parameter regimes that produce different neuronal firing states have been well characterized earlier.

### 8.1.1 Dynamical Model for Input-Sensor Nodes in the Lower Layer (Layer-I):

$$\frac{d {v}_{i}}{d t} = 0.04 {v}_{i}^{2} + 5 {v}_{i} + 140 - {u}_{i} + {\sum }_{j = 1}^{N} {S}_{i , j} ℋ ( {v}_{j} - 30 ) + {η}_{i} ( t )$$

$$\frac{d {u}_{i}}{d t} = {a}_{i} ( {b}_{i} {v}_{i} - {u}_{i} )$$

with the auxiliary after-spike reset:

$${v}_{i} ( t ) > 30 , then : \{ \begin{matrix}{v}_{i} ( t + Δ t ) = {c}_{i} \\ {u}_{i} ( t + Δ t ) = {u}_{i} ( t ) + {d}_{i}\end{matrix}$$

where: (1) vᵢ is the activity of sensor node i; (2) uᵢ captures the recovery of sensor node i; (3) S_{i,j} is the connection weight between sensor-nodes i and j; (4) N is the number of sensor-nodes in layer-I; (5) Parameters aᵢ and bᵢ are set to 0.02 and 0.2 respectively, while cᵢ and dᵢ are sampled from the distributions [symbol] (−65, −50) and [symbol] (2,8) respectively. Once set for every node, the parameters remain constant during the process of self-organization. The initial values for vᵢ(0) and uᵢ(0) are set to −65 and −13 respectively for all nodes. These values are taken from Izhikevich's neuron model; (6) ηᵢ(t) models the noisy behavior of every node i in the system, where <ηᵢ(t)ηⱼ(t′)>=σ² δ_{i,j}δ(t−t′). Here, δ_{i,j}, δ(t−t′) are Kronecker-delta and Dirac-delta functions respectively, and σ²=9; (7) [symbol] is the unit step function:

$$ℋ ( {v}_{i} - 30 ) = \{ \begin{matrix}1 , & {v}_{i} \geq 30 \\ 0 , & {v}_{i} < 30\end{matrix} .$$

### 8.2 Topology of Input-Sensor Nodes

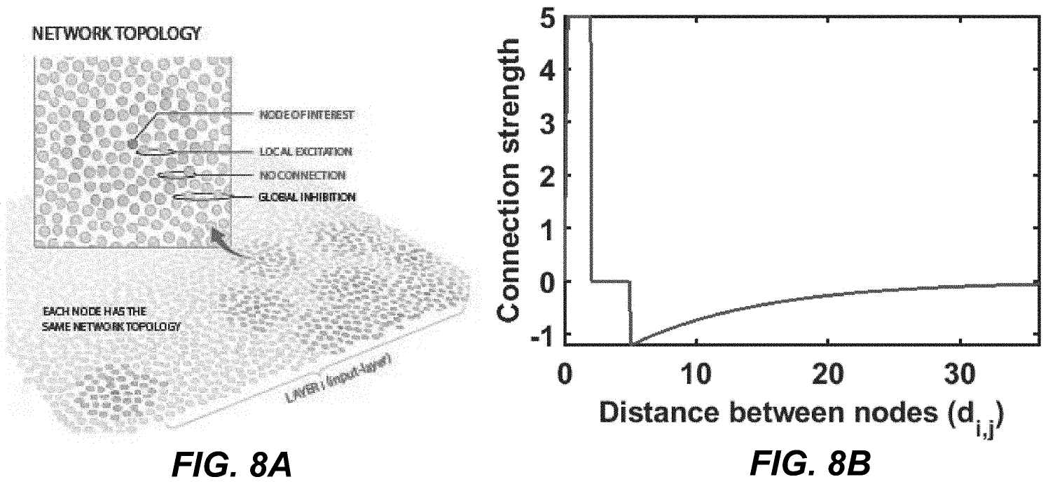

The nodes in the lower layer (layer-I) are arranged in a local-excitation, global inhibition topology, with a ring of nodes between the excitation and inhibition regions that have neither excitation nor inhibition (zero weights). The zero-weight ring that has no connections between the excitation and inhibition regions gives a good control over the emergent wave size. This is detailed in section 8.2.1 and depicted in FIGS. 8A-8B.

FIGS. 8A-8B. Topology of sensor-node connections. Every node is connected to other nodes in the layer within a radius rₑ via a positive weight, not connected to nodes positioned at a distance between rₑ and rᵢ and connected to nodes at a distance larger than rᵢ with a decaying negative weight.

### 8.2.1 Topology of Input-Sensor Nodes in Layer-I

This topology is pictorially depicted in FIGS. 8A-8B and mathematically defined below:

$${S}_{i , j} = \{ \begin{matrix}l , & {d}_{i , i} \leq {r}_{e} \\ m exp ( \frac{- {d}_{i , j}}{10} ) , & {d}_{i , j} \geq {r}_{i} \\ 0 & {r}_{e} < {d}_{i , j} < {r}_{i}\end{matrix}$$

where:
S_{i,j} is the connection weight between sensor-nodes i and j
d_{i,j} is the Euclidean distance between sensor-nodes i and j in layer-I
rₑ is the local excitation radius (rₑ=2)
rᵢ is the global inhibition radius (all nodes present outside this radius are inhibited) (rᵢ=4)
l is the magnitude of excitation (l=5)
m is the magnitude of inhibition (m=−2)

### 8.3 Modeling Processing Units and Winner-Take-all Strategy

Processing units are modeled as Rectified linear units (ReLU) associated with an arbitrary threshold. Although the threshold is randomly initialized, it is updated during the process of self-organization. Threshold update depends entirely on the activity trace of the associated processing unit. A requirement is that at every time point, at most a single processing unit in layer-II be activated by the emergent patterned activity in layer-I. To enforce single layer-II unit firing, the processing units, modeled as ReLU units, compete with each other in a winner-take-all (WTA) manner. WTA dynamics ensures that at every time point, at most a single unit in layer-II responds to the patterned activity in the input layer.

Each processing unit in layer-II is modeled by the equation given below:

$${y}_{j} ( t ) = W [ max ( 0 , {\sum }_{i = 1}^{N} {w}_{i , j} ( t ) ℋ ( {v}_{i} ( t ) - 30 ) ) ]$$

Here, the max(0, x) is the implementation of a rectified linear unit (ReLU); [symbol] (vᵢ(t)−30) is the threshold activity of sensor node i (in layer-I) at time ‘t’; yⱼ(t) is the activation of processing unit j (in layer-II) at time T; w_{i,j}^{t} is the connection weight between sensor-node i and processing unit j at time ‘t’; N is the number of sensor-nodes in layer-I and [symbol] refers to the winner-take-all mechanism that ensures a single winning processing unit.

The winner-take-all function implemented in layer-II is mathematically elaborated below:

$$W [ {y}_{j} ( t ) ] = \{ \begin{matrix}max ( 0 , {y}_{j} ( t ) - {c}_{j} ( t ) ) , & if {y}_{j} ( t ) > {y}_{k} ( t ) ∀ k ∈ [ 1 , … j - 1 , j + 1 , … , M ] \\ 0 & otherwise\end{matrix}$$

Here, yⱼ (t) is the activation of processing unit j (in layer-II) at time ‘t’; cⱼ (t) is the threshold for processing unit j at time ‘t’ and M is the number of processing units in layer-II. Every processing unit is modeled as a ReLU with an associated threshold (c₁). Although this threshold is arbitrarily initialized, the threshold is updated during the process of self-organization. The update depends on the number of times the connections between processing units and nodes in layer-I are updated as described below.

To implement threshold update, the algorithm keeps track of the number of times connections between a specific processing unit and sensor nodes in layer-I are updated over the course of 1000 time-points. zⱼ (t) captures the number of times connections between processing unit-j and sensor-nodes in layer-I are updated.

### 8.3.1 Topology of Input-Sensor Nodes in Layer-I

$${z}_{j} ( t + 1 ) = \{ \begin{matrix}{z}_{j} ( t ) + 1 & if ( {y}_{j} ( t ) > 0 ) \\ 0 & if ( t mod 1000 ) = 0 \\ {z}_{j} ( t ) & otherwise\end{matrix}$$

The threshold for a processing unit is updated based on the number of connections that were altered in the past 1000 time points between that processing unit and sensor-nodes in layer-I.

### 8.3.2 Updating the Threshold for Every Processing Unit

$${c}_{j} ( t + 1 ) = \{ \begin{matrix}max ( {y}_{j} ( t ) , {y}_{j} ( t - 1 ) , … , {y}_{j} ( 0 ) ) / 5 , & if ( t mod 1000 ) = 0 AND {z}_{j} ( t ) < 200 \\ {c}_{j} ( t ) & otherwise\end{matrix}$$

Here, w_{i,j}(t) is the weight of connection between sensor-node i and processing unit j at time ‘t’; ηₗₑₐᵣₙ is the learning rate; yⱼ^{t} is the activation of processing unit j at time ‘t’; zⱼ (t) is the number of synaptic modifications made to unit j until time T; (t mod 1000) is the remainder when t is divided by 1000 and cⱼ(t) is the activation threshold for processing unit j at time ‘t’.

The emergent wave in layer-I coupled with the learning rule implemented by processing units in layer-II are sufficient to self-organize pooling architectures.

### 9 Growing a Neural Network

By defining a minimal set of ‘rules’ for a single computational ‘cell’, a layered network can be grown, followed by the self-organization of its inter-layer connections to form pooling layers.

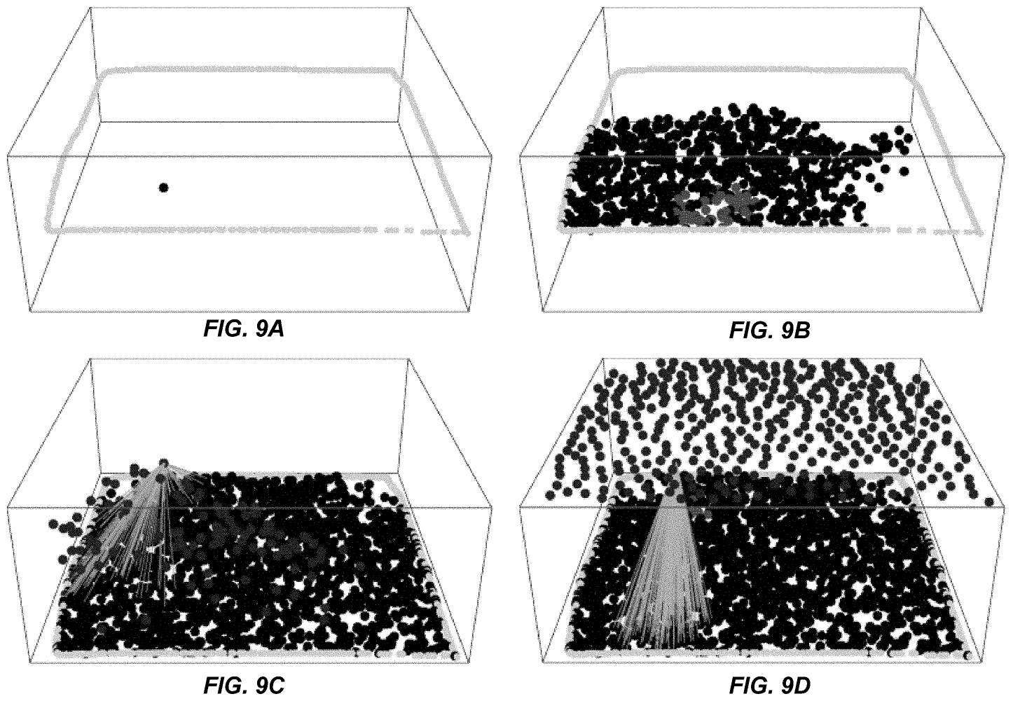

In order to grow a layered network, a 3D scaffold is defined and the first layer in the scaffold is seeded with a computational ‘cell’ (FIGS. 9A-9D). The major attributes of nodes in the first layer are:
vᵢ(t): activity of node i modeled by the Izhikevich equation
clockHᵢ: records the age of the ‘cell’, allowing horizontal division (division within the same layer) until it reaches a certain age
HFlimᵢ: the maximum divisions permitted for node i
VCDᵢ: a binary variable that records whether node i has vertically divided or not. Vertical division is the process when a ‘cell’ divides and its daughter ‘cells’ migrate upwards to form processing units that populate higher layers.

FIGS. 9A-9D. Growing a layered neural network. FIG. 9A. A single computational “cell” (black node) is seeded in a scaffold defined by the grey boundary. FIG. 9B. Once this “cell” divides, daughter cells make local-excitatory and global-inhibitory connections. As the division process continues, noisy interactions between nodes results in emergent spatiotemporal waves (red nodes). FIG. 9C. Some nodes within layer-I divide to produce daughter cells that migrate upwards to form processing units (blue nodes). The connections between the two layers are captured by the lines that connect a single unit in a higher layer to nodes in the first layer (Only connections from a single unit are shown). FIG. 9D. After a long duration, the system reaches a steady state, where two layers have been created with an emergent pooling architecture.

### 9.1 User-Defined Growth Parameters

TABLE 1.1
User-defined growth parameters.

| Parameter | Value | Description |
|---|---|---|
| HCD_AGE | 25 | The maximum time a cell can pursue horizontal |
| | | division |
| HF_MAX | 40 | The maximum number of divisions a single cell |
| | | can pursue |
| R_HDIV | 1 | Critical radius I |
| R_VDIV | 1 | Critical radius II |
| THRESH_HDIV | 3 | The maximum number of cells permitted within |
| | | a radius (R_HDIV) |

### 9.2 Growth Process

### 9.2.1 Step: 1

A single computational ‘cell’ endowed with the following attributes is seeded on a 3D scaffold. The attributes and values that a seeded computational ‘cell’ is endowed with is mentioned in the table below. The first column indicates attributes, second column denotes the initial values that the attributes take, and the third column is a description of the attribute.

TABLE 1.2
Attributes of a single computation ‘cell.’

| Cell | | |
|---|---|---|
| attribute | Initialization | Description |
| v | −65 | Initialize activity of node i |
| clockH | 0 | Initializing clock to 0, for every newly divided |
| | | daughter cell |
| HFlim | HF_MAX | Initializing the max divisions to HF_MAX for |
| | | the seeded cell. |
| VCD | 0 | Before vertical division, VCDᵢ = 0; After vertical |
| | | division, VCDᵢ = 1; |

9.2.2 Step: t→t+1

A random cell i is sampled from the input layer.

If the cell has not crossed the critical age threshold (clockHᵢ<HCD_AGE) and the number of cells within a radius (R_HDIV) is below the density threshold (numCellsᵢ(R_HDIV)<THRESH_HDIV), the cell divides horizontally to form daughter cells that populate the same layer. The clockH is reset to zero for the daughter cells, however the HFlim attribute of the daughter cells is one less than their parent to keep track of the number of divisions.

If the cell has not reached the critical age threshold, but has a local density above the defined density threshold, the cell remains quiescent and a new ‘cell’ is sampled.

A cell i can divide vertically only if the cell has reached the critical age threshold (clockHᵢ=HCD_AGE) and cells in its local vicinity (with radius:-R_VDIV) haven't divided vertically. As mentioned in an earlier section, a binary variable VCDᵢ keeps track of whether a cell has divided vertically or not.

When a cell divides vertically, one daughter cell occupies the parent's position on layer-I, while the other daughter cell migrates upwards. The daughter cell that migrates upwards initially makes a single connection with its twin on layer-I, which gets modified with time, resulting in a pool of nodes in layer-I making connections with a single unit in the higher layer (pooling architecture).

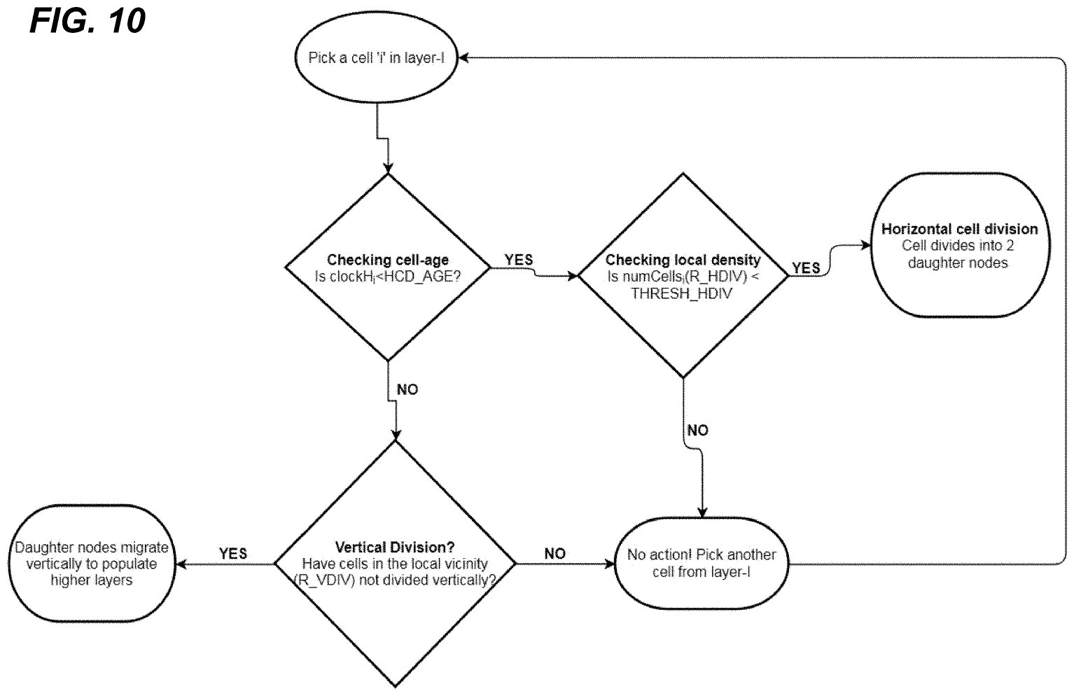

FIG. 10. Growth flowchart.

### 9.2.3 Termination Condition

The local rules that control horizontal division and vertical division are active throughout and prevent the system from blowing up, with respect to the number of nodes in each layer. The system reaches a steady state, as the number of ‘cells’ in both layers remain constant.

### 9.3 Growing Neural Networks on Arbitrary Scaffolds (Results)

Videos of multi-layered networks growing on arbitrary scaffolds can be viewed at https://drive.google.com/open?id=1YtFEvWHTU9HW1760V81Er9Heapx0sUdh (each of which is incorporated herein by reference in its entirety).

### 10 Minimal Model for Observing Emergent Spatiotemporal Waves

This section provides an analytical solution for the emergence of a spatiotemporal wave through noisy interactions between constituent nodes in the same layer.

The key ingredients for having a layer of nodes function as a spatiotemporal wave generator are:
Each sensor-node should be modeled as a dynamical systems model
Sensor-nodes should be connected in a suitable topology (here, local excitation (rₑ<2 and global inhibition (rᵢ>4).

On modeling all nodes in the system using a simple set of ordinary differential equations (ODEs), this section highlights the conditions required for observing a stationary bump in a network of spiking sensor-nodes and to observe instability of the stationary bump resulting in a traveling wave.

### 10.1 Arranging Sensor-Nodes in a Line

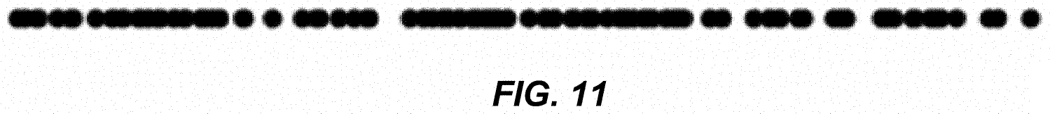

A configuration was chosen where N sensor-nodes are randomly arranged in a line (as shown in FIG. 11).

The activity of N sensor nodes, arranged in a line as in FIG. 11, are modeled using a minimal ODE model as described below:

$${τ}_{d} \frac{dx ( {u}_{i} , t )}{dt} = - x ( {u}_{i} , t ) + {\sum }_{{u}_{j} ∈ 𝒰} S ( {u}_{i} , {u}_{j} ) ℱ ( x ( {u}_{j} , t ) )$$

$$∀ i ∈ 1 , … , N$$

Here, uᵢ represents the position of nodes on a line; x(uᵢ, t) defines the activity of sensor node positioned at uᵢ at time t; S_{ui,uj} is the strength of connection between nodes positioned at uᵢ and uⱼ; τ_{d} controls the rate of decay of activity; [symbol] is the set of all sensor nodes in the system (u₁, u₂, . . . , u_{N}) for N sensor nodes; and is the non-linear function required to convert activity of nodes to spiking activity. Here, [symbol] is the heaviside function with a step transition at 0.

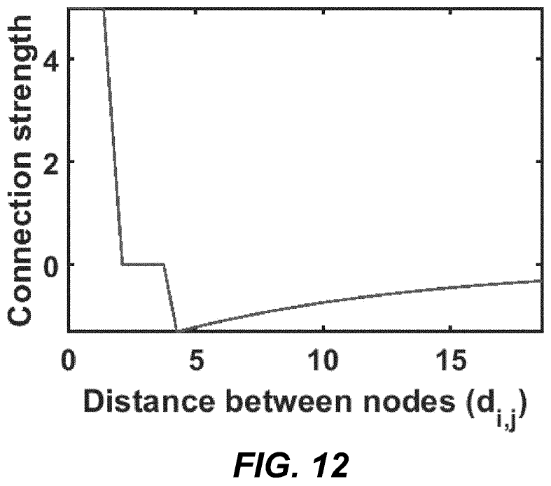

Each sensor-node in this example has the same topology of connections, i.e. fixed strength of positive connections between nodes within a radius rₑ, no connections from a radius rₑ to rᵢ, and decaying inhibition above a radius rᵢ, depicted in FIG. 12.

### 10.1.1 Fixed Point Analysis

The stable activity states of nodes placed in a line was determined by a fixed point analysis.

$$x ( {u}_{i} ) = {\sum }_{{u}_{j} ∈ 𝒰} S ( {u}_{i} , {u}_{j} ) ℱ ( x ( {u}_{j} ) ) \qquad ∀ i ∈ 1 , … , N$$

On solving this system of non-linear equations simultaneously, a fixed point i.e., a vector x*∈ [symbol] ^{N}, corresponding to the activity of N sensor nodes positioned at (u₁, u₂, . . . , u_{N}) is obtained. Their spiking from the activity of sensor-nodes was assessed using

sᵢ= [symbol] (x(uᵢ))∀i∈1, . . . ,N

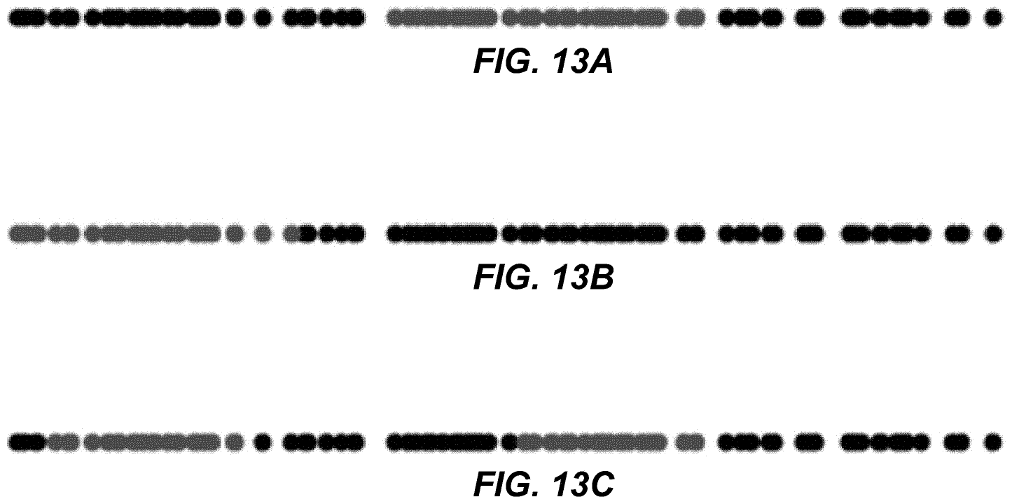

As the weight matrix (S_{ui,uj}) used incorporates the local excitation (rₑ<2) and global inhibition (rᵢ>4) (FIG. 12), the following solutions are obtained: solutions with a single bump of activity (FIG. 13A), two bumps of activity FIG. 13C) or a state when all nodes are active.

FIGS. 13A-13C. Fixed points: Multiple fixed points are obtained by solving N non-linear equations simultaneously. Some of the solutions obtained are: (FIG. 13A) a single bump at the center, (FIG. 13B) a single bump at one of the edges, and (FIG. 13C) two bumps of activity.

### 10.1.2 Stability of Fixed Points

To assess the stability of these fixed points, the eigenvalues of the Jacobian are evaluated for this system of differential equations. As there are N differential equations, the Jacobian ( [symbol] ) is an N×N matrix.

$$\frac{dx ( {u}_{i} , t )}{dt} = \frac{- x ( {u}_{i} , t )}{{τ}_{d}} + {\sum }_{{u}_{j} ∈ 𝒰} \frac{S ( {u}_{i} , {u}_{j} ) ℱ ( x ( {u}_{j} ) )}{{τ}_{d}}$$

$$\frac{dx ( {u}_{i} , t )}{dt} = {f}_{i} ( {u}_{1} , {u}_{2} , … , {u}_{N} )$$

$${f}_{i} ( {u}_{1} , {u}_{2} , … , {u}_{N} ) = \frac{- x ( {u}_{i} )}{{τ}_{d}} + {\sum }_{{u}_{j} ∈ 𝒰} \frac{S ( {u}_{i} , {u}_{j} ) ℱ ( x ( {u}_{j} ) )}{{τ}_{d}}$$

$$( i , j ) = \frac{\partial {f}_{i} ( {u}_{1} , {u}_{2} , … , {u}_{N} )}{\partial x ( {u}_{j} )}$$

On evaluating the Jacobian ( [symbol] ) at the fixed points obtained (x*), the following are obtained:

$$( i , i ) = \frac{\partial {f}_{i}}{\partial x ( {u}_{i} )}$$

$$( i , i ) = \frac{- 1}{{τ}_{d}}$$

$$( i , j ) = S ( {u}_{i} , {u}_{j} ) {ℱ}^{′} ( x ( {u}_{j} ) ) \frac{\partial x ( {u}_{j} )}{x ( {u}_{j} )}$$

$$( i , j ) = S ( {u}_{i} , {u}_{j} ) δ ( x ( {u}_{j} ) )$$

$$( i , j ) = 0 ∀ x ( {u}_{j} ) \neq 0$$

Here, [symbol] is the Heaviside function and its derivative is the dirac-delta(δ); where, δ(x)=0, for x≠0 and δ(x)=∞ for x=0.

For a fixed point, where x*(uₖ)≠0, ∀k∈1, . . . , N, the Jacobian is a diagonal matrix with

$$\frac{- 1}{{τ}_{d}}$$

in its diagonals. This implies that the eigenvalues of the Jacobian are

$$\frac{- 1}{{τ}_{d}} ( {τ}_{d} > 0 ) ,$$

which assures that the fixed point x*∈ [symbol] ^{N} is a stable fixed point.

### 10.1.3 Destabilizing the Fixed Point

With the addition of high amplitude of Gaussian noise to the ODEs described earlier, the fixed point can be effectively destabilized, resulting in a traveling wave. The equations with the addition of a noise term are:

$${τ}_{d} \frac{d x ( {u}_{i} , t )}{d t} = - x ( {u}_{i} , t ) + {\sum }_{{u}_{j} ∈ 𝒰} S ( {u}_{i} , {u}_{j} ) ℱ ( x ( {u}_{j} , t ) ) + {η}_{i} ( t )$$

$$∀ i ∈ 1 , … , N$$

Here, ηᵢ(t) models the noisy behavior of every node i in the system, where <ηᵢ(t)ηⱼ(t′)>=σ²δ_{i,j}δ(t−t′). Here, δ_{i,j}, δ(t−t′) are Kronecker-delta and Dirac-delta functions respectively, and σ² captures the magnitude of noise added to the system.

The network of sensor nodes is robust to a small amplitude of noise (σ²∈(0,4)), while a larger amplitude of noise (σ²>5) can destabilize the bump, forcing the system to transition to another bump in its local vicinity. Continuous addition of high amplitudes of noise forces the bump to move around in the form of traveling waves. The behavior is consistent with the linear stability analysis because noise can push the dynamical system beyond the envelop of stability for a given fixed point solution.

### 10.2 Arranging Sensor Nodes in a 2D Square

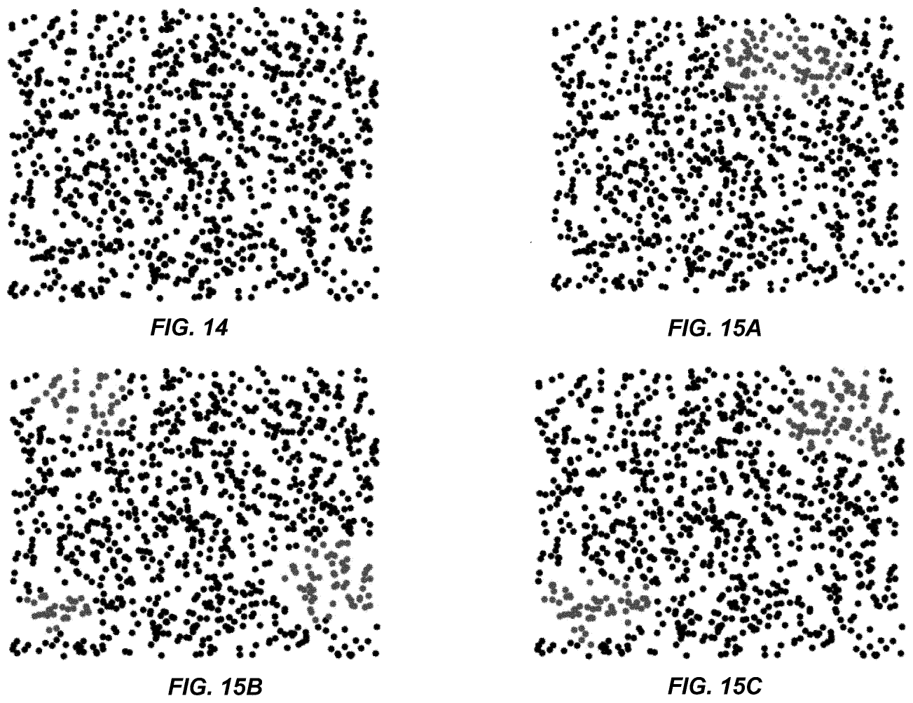

In this section, N sensor nodes are arranged arbitrarily on a 2D square as shown in FIG. 14, with the same local structure (local excitation and global inhibition).

The activity of these sensor nodes are modeled using the minimal ODE model described in section 10.1.

The fixed points (x*∈ [symbol] ^{N}) are obtained by solving N simultaneous non-linear equations using BBsolve. The fixed point solutions have a variable number of activity bumps in the 2D plane as shown in FIGS. 15A-15C.

FIGS. 15A-15C. Stable Fixed points. Multiple fixed points are obtained by solving N non-linear equations simultaneously. Some of the solutions obtained are: (FIG. 15A) a single bump, (FIG. 15B) two bumps, and (FIG. 15C) three bumps of activity.

### 10.3 Arranging Sensor Nodes on a 2D Sheet of Arbitrary Geometry

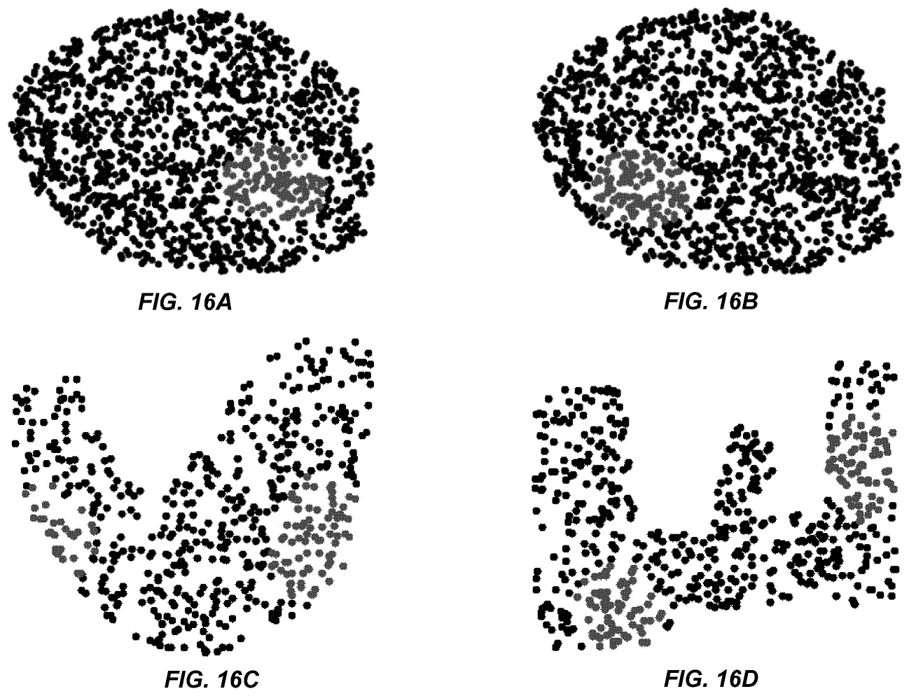

In this section, sensor nodes are arranged on a 2D sheet in any arbitrary geometry as shown in FIGS. 16A-16D. Although the macroscopic geometry of the sheet changes, the local structure of sensor nodes is conserved (i.e., local excitation and global inhibition).

The fixed points are evaluated by simultaneously solving the non-linear system of equations. The bumps are stable fixed points even when sensor nodes are placed on a 2D sheet of arbitrary geometry.

FIGS. 16A-16D. Stable Fixed points. Multiple fixed points are obtained by solving N non-linear equations simultaneously. Some of the solutions obtained are: (FIGS. 16A-16B) a single bump for a circular geometry (FIGS. 16C-16D) two bumps of activity for arbitrary geometry.

### 11 Growing Functional Neural Networks

Functionality of networks grown and self-organized from a single unit is estimated by evaluating their train and test accuracy on a classification task. Here, networks are trained to classify images of handwritten digits obtained from the MNIST dataset. To interpret the results, the train-test accuracy of self-organized networks are compared with the train/test accuracy of hand-crafted pooling networks and random networks. Hand-crafted pooling networks have a user-defined pool size for all units in layer-II, while random networks have units in layer-II that connect to a random set of nodes in layer-I without any spatial bias, effectively not forming a pooling layer.

To test functionality of these networks, the two-layered network is coupled with a linear classifier that is trained to classify hand-written digits from MNIST on the basis of the representation provided by these three architectures (hand-crafted, self-organized and random networks).

The first two layers in the network serve as feature extractors, while the last layer behaves like a perceptron. The optimal classifier is learnt by minimizing the least square error between the output of the network and a desired target. However, there isn't any back-propagation through the entire network. In essence, in some embodiments the architecture grown through the developmental algorithm remains fixed, performing the task of latent feature representation, while the classifier learns how to match these latent features with a set of task-based labels.

### 11.1 Setting Up the Pooling Architecture

The first two layers of the network correspond to the pooling architecture grown by the developmental algorithm. The input is fed to the first layer, while the units in the second layer, that are connected to spatial pools in layer-I, extract features from these inputs.

Let x∈ [symbol] ^{N} be the input data (for N sensor nodes) and the weights connecting the first and second layer be W₁∈ [symbol] ^{M×N} (for M processing units). The features extracted in layer-II are: y=F [symbol] (W₁x). Here, [symbol] is any non-linear function applied to the transformation in order to map all the values in layer-II within the range [−1,1].

11.2 Appending a fully connected layer

The pooling architecture sends its feature map through a fully connected layer with L nodes, with the weights connecting the set of processing units and the fully connected layer being randomly initialized as W₂∈ [symbol] ^{L×M}. The features extracted by the fully connected layer are: y_{FC}= [symbol] (Wy). [symbol] is the same as the one used in section 11.1.

### 11.3 Classification Accuracy

The final set of weights connecting the fully connected layer to the 10-element vector (as there are 10 digit classes in the MNIST dataset) is denoted by W₃∈ [symbol] ^{10×L}. The output generated by the network is y_{O}=W₃y_{FC}. The target output is denoted as y_{T}.

To minimize the least square error between the target output (y_{T}) and output of the network (y_{O}), conventionally, a gradient descent is performed. However, as the classifier is a linear classifier, there is a closed form solution for the weight matrix (W₃).

y_{O}=W₃y_{FC}

y_{T}=W₃y_{FC} for zero error,y₀=y_{T}

y_{T}y_{FC}^{T}=W₃y_{FC}y_{FC}^{T}

W₃=y_{T}y_{FC}^{T}(y_{FC}y_{FC}^{T})

Setting the weights between the fully connected layer and the output layer (W₃=y_{T}y_{FC}^{T}(y_{FC}y_{FC}^{T}), the train and test accuracy for 3 kinds of networks (hand-crafted pooling, self-organized and random networks) is evaluated. These networks differ primarily in how their first two layers are connected. The hand-programmed pooling networks are those that have a fixed size of spatial pool that connects to units in layer-II, while the random networks have no spatial pooling.

The results are described above in the example. Self-organized networks classify with a 90% test accuracy, which is statistically similar to the test accuracy of hand-crafted pooling networks (90.5%, p-value=0.1591) and statistically better than random networks (88%, p-value=5.6×10⁻⁵) (FIG. 7A). This performance is consistent over multiple self-organized networks. The train/test accuracy of self-organization networks highlights that growing networks through a brain-inspired developmental algorithm is potentially useful to building functional networks.

### 12 Scalability: Determining the Speed of Self-Organization of the Pooling Architecture as the Size of the Input-Layer Increases

The pooling layers can be self-organized for very large input layers. Large layers are defined based on the number of sensor nodes in the layer. Enforcing a spatial bias on the initial set of connections from units in layer-II to the nodes in the input layer enable speeding up the process of self-organization.

Simulations show that the self-organization of pooling layers can be scaled up to large layers (for example, with up to 50000 nodes) without being very expensive, as an increase in number of sensor-nodes results in multiple simultaneous waves tiling the input layer, effectively forming a pooling architecture in parallel.

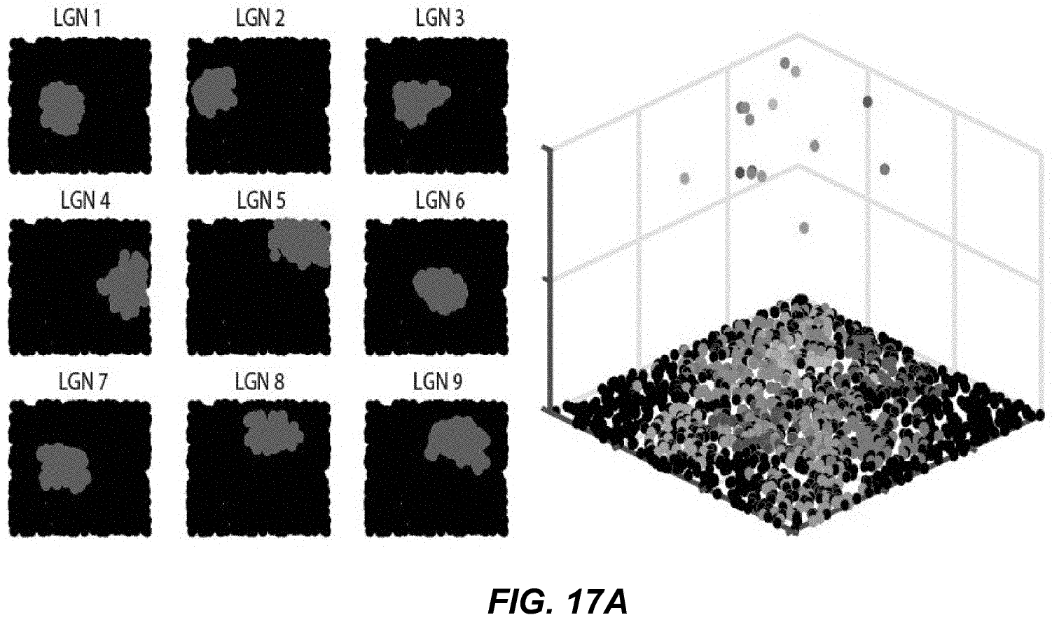

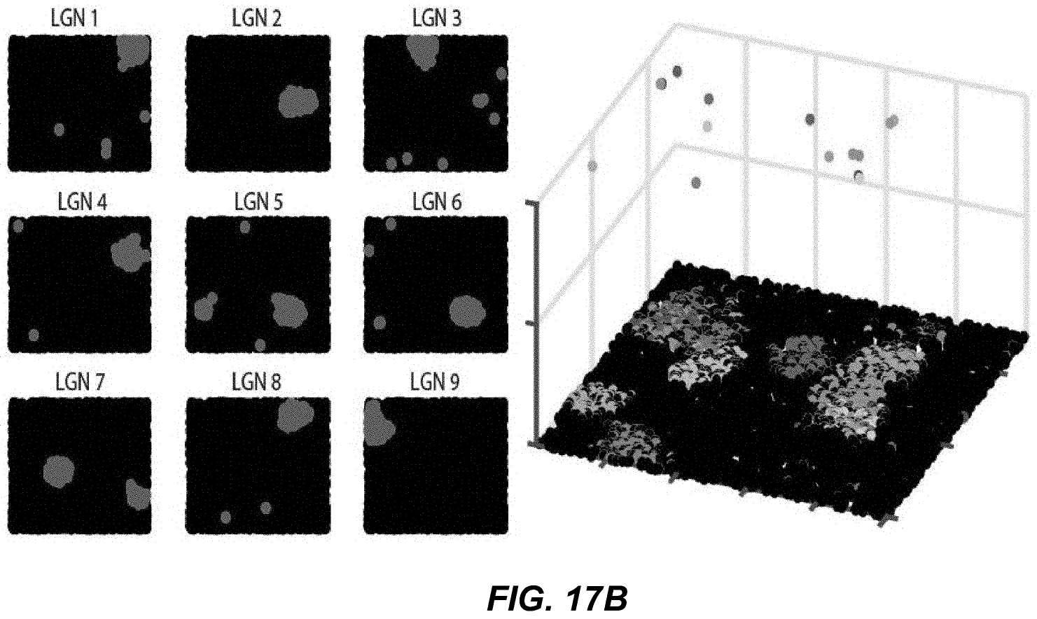

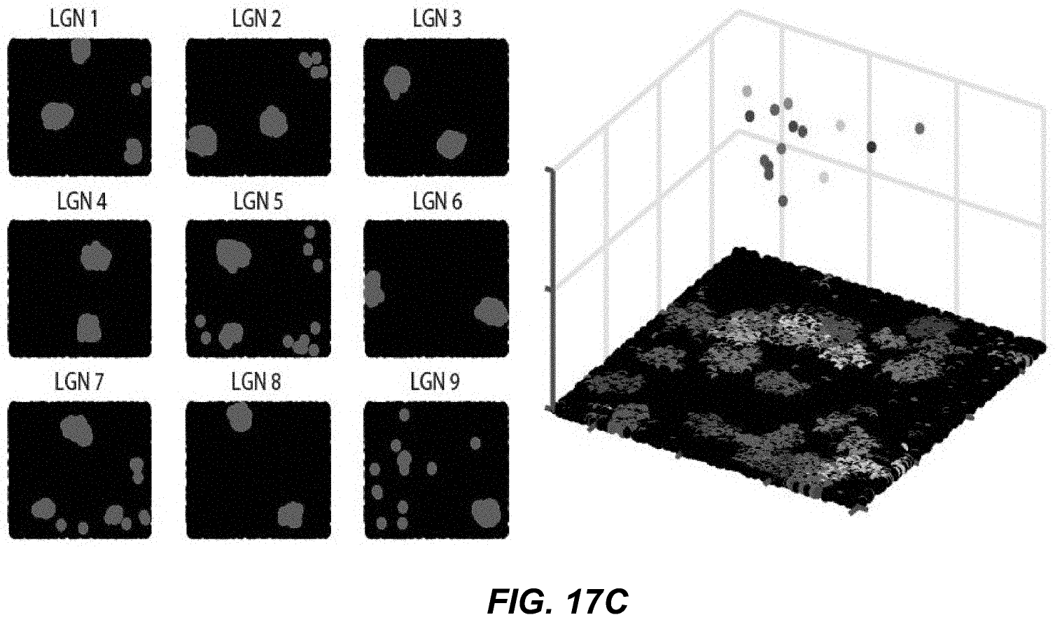

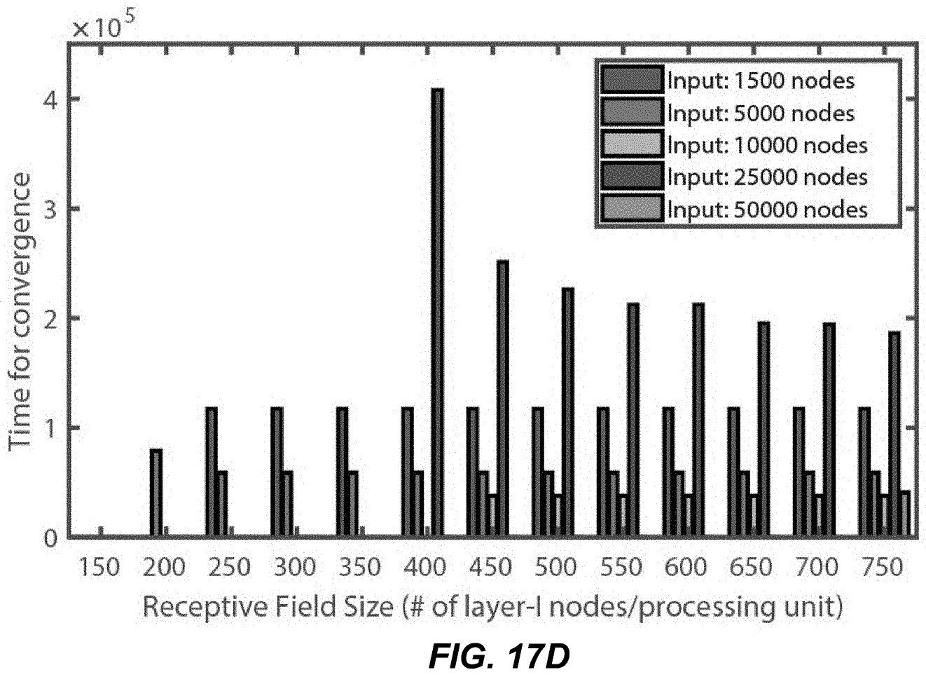

FIGS. 17A-17D. Developmental algorithm scales efficiently to very large input layers. FIG. 17A. Layer-I has 1500 nodes and layer-II has 400 nodes. The emergent wave in layer-I results in a single traveling wave that tiles layer-I. FIG. 17B. Layer-I has 5000 nodes and layer-II has 400 nodes. The emergent wave in layer-I results in a single traveling wave that tiles layer-I. FIG. 17C. Layer-I has 10000 nodes and layer-II has 400 nodes. The emergent wave in layer-I results in a multiple traveling wave that tile layer-I simultaneously, which results in a single processing unit receiving pools from different regions. FIG. 17D. Time complexity for self-organization of pooling layers. The histogram captures the time taken for a pooling layer to form for variable number of input sensor nodes (1500, 5000, 10000, 25000 and 50000 nodes). With an increase in the number of sensor-nodes, the speed of self-organization increases as multiple waves tile the input layer simultaneously.

### Example 2

### Self-Organization of Multi-Layer Spiking Neural Networks

Living neural networks in human brains autonomously self-organize into large, complex architectures during early development to result in an organized and functional organic computational device. A key mechanism that enables the formation of complex architecture in the developing brain is the emergence of traveling spatiotemporal waves of neuronal activity across the growing brain. Inspired by this strategy, the example illustrates efficient self-organization large neural networks with an arbitrary number of layers into a wide variety of architectures. To achieve this, this example describes a modular tool-kit in the form of a dynamical system that can be seamlessly stacked to assemble multi-layer neural networks. The dynamical system encapsulates the dynamics of spiking units, spiking units' inter/intra layer interactions as well as the plasticity rules that control the flow of information between layers. The key features of the tool-kit are (1) autonomous spatiotemporal waves across multiple layers triggered by activity in the preceding layer and (2) Spike-timing dependent plasticity (STDP) learning rules that update the inter-layer connectivity based on wave activity in the connecting layers. The framework leads to the self-organization of a wide variety of architectures, ranging from multi-layer perceptrons to autoencoders. This example also demonstrates that emergent waves can self-organize spiking network architecture to perform unsupervised learning, and networks can be coupled with a linear classifier to perform classification on classic image datasets like MNIST. Broadly, this example shows that a dynamical systems framework for learning can be used to self-organize large computational devices.

### 1 Introduction

Biological neural networks in brains are remarkable machines that endow an organism with the ability to perform an array of computational and information processing tasks. In addition, biological neural networks are fascinating as biological neural networks grow from a single precursor cell and self-organize into complex architectures. The self-organization process in biological networks leads to a wide variety of architectures ranging from feed-forward networks for visual processing in the visual cortex to recurrent neural networks for memory systems deployed in the hippocampus.

One of the key mechanisms that guides the self-organization process in a developing embryo's neural networks is the emergence of spatiotemporal neural activity waves across multiple regions of the brain. Traveling activity waves in the developing brain carry significant information to achieve two major purposes: (i) wiring local networks into specific architectures and (ii) for initiating the maturation of neural circuitry.

Example 1 is a demonstration of utilizing spontaneous traveling waves to self-organize a two-layered neural network. The strategy was successful in self-organizing retinotopic pooling layers of variable pool-sizes of a two layered neural network. Neural networks composed of spiking nodes are of great interest to the fields of AI and neuroscience, for spike nodes model the dynamics of neurons in the brains closely, can be trained to perform AI-relevant tasks through strategies that are more biologically plausible, are apt models to study self-organization of living neural systems and can be implemented on neuromorphic hardware.

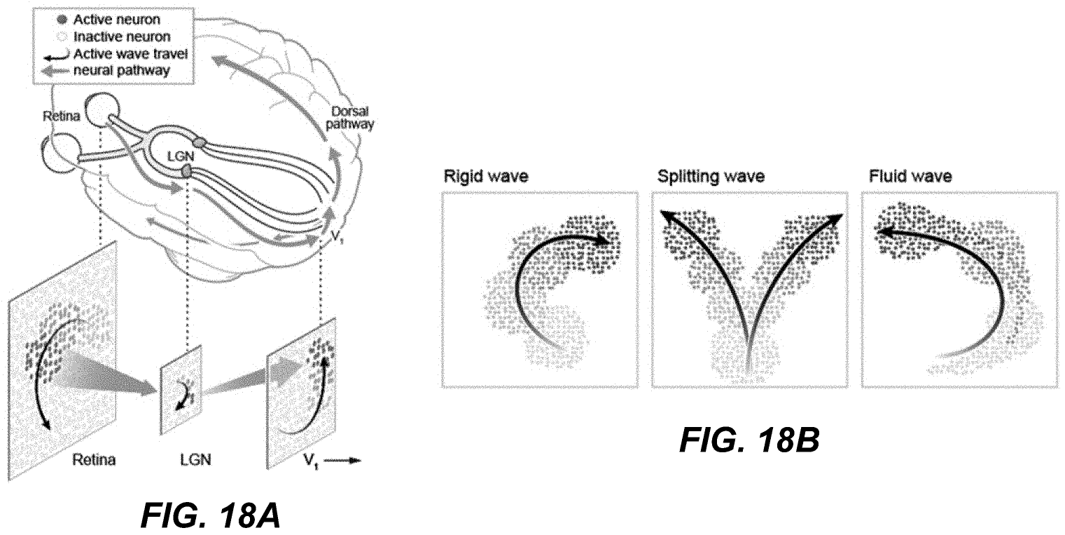

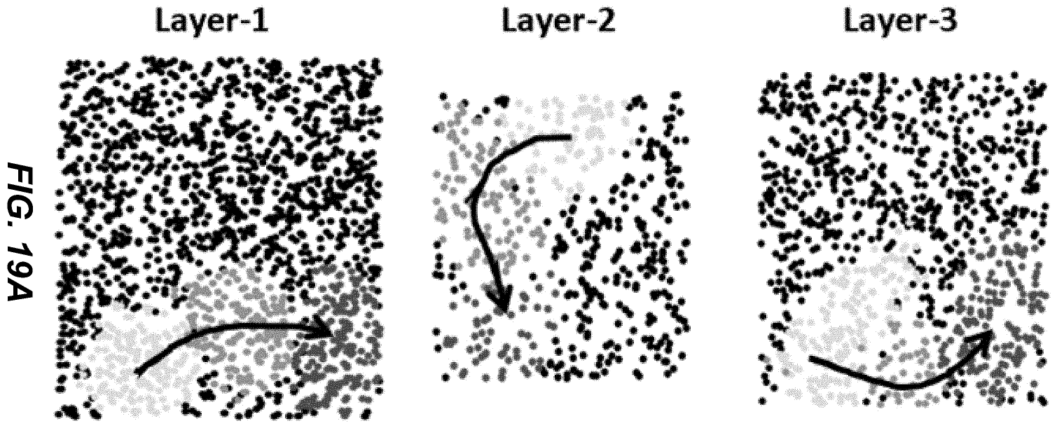

In this example, strategies are developed to self-organize large spatially-connected, multi-layer spiking neural networks (SNN), inspired by the wiring rules and mechanisms adopted by the mammalian visual system during development. The visual circuitry, specifically the connectivity between the retina, LGN and the early layers of the visual cortex have stereotypical architectures across organisms, namely pooling connectivity between retina and LGN, and an expansion from the LGN to V1. The connectivity is established by the emergence of multiple traveling waves (FIGS. 18A-18B) across the retina and different cortical regions much before the onset of vision.

FIGS. 18A-18B. Spontaneous waves in the developing brain. FIG. 18A. Emergent neuronal waves across the visual circuitry (Retina, LGN and V1). FIG. 18B. Multiple types of wave dynamics.

This example describes a modular tool-kit in the form of a dynamical systems framework to seamlessly self-organize large neural networks, inspired by cortical developmental processes. The modular structure of the tool-kit allows scaling the network on demand and rapidly evolve neural architectures, by modifying the components of a module. The example shows that the tool-kit can seamlessly trigger neural activity waves across multiple layers in the network, followed by simultaneous self-organization of inter-layer weights, effectively speeding up the process of self-organization. The algorithm described in this example allows self-organization of a wide variety of feedforward neural architectures, like multi-layer retinotopic layers and autoencoders. The ability to self-organize large networks of spiking units in a modular fashion is extremely relevant for the field of neuromorphic computing. Additionally, the framework established can be very useful for self-organizing large-scale models of the brain.

### 2 Related Work

Modeling the self-organization of neural networks (NNs) dates back many years, with the first demonstration being Fukushima's neocognitron. Neocognitron was built out of simple McCulloch-Pitts neuron units, arranged in a hierarchical multi-layer neural network, capable of learning to perform pattern-recognition. Although the weights connecting the different layers were modified via unsupervised learning paradigms, the architecture of the network was hard-coded, which was inspired by Hubel and Wiesels' model of simple and complex cells in the visual cortex. The neocognitron design inspired modern day artificial NNs (ANNs) and convolutional NNs (CNNs). ANNs and CNNs trained via global learning rules, like backpropagation, have been extremely successful in performing image-based tasks. However, ANNs rely on hand-designed architectures for their functioning and suffer from the bottleneck of requiring massive datasets to learn efficiently. On the contrary, biological neural networks in the brain grow and self-organize a neural architecture that can generalize very well to innumerable datasets without requiring a massive training dataset. Inspired by the prowess of biological brains, the 3rd generation of NNs, namely SNNs, was proposed. SNNs are built out of ‘neuron’ units that mirror the dynamics of living neurons. Although very promising, simulating large SNNs on conventional CPU's is very inefficient and time-consuming. The introduction of neuromorphic hardware, like IBM's TrueNorth and Intel's Loihi, provided the right platform for simulating large (deep) SNNs for long time-periods, enabling networks to make inferences on a wide range of tasks. However, as SNNs are built out of dynamical units (spiking ‘neurons’), SNNs are extremely sensitive to the initial wiring architecture. An efficient self-organization routine to autonomously wire a two layered spiking neural network has been demonstrated. The self-organization is driven by traveling spatiotemporal activity waves in the first layer, that ultimately lead to the formation of pooling structures. However, the strategy needs extensions for the self-organization of (deep) SNNs with multiple layers. The significant challenge in constructing multi-layer SNNs has been the decreasing spiking input signal intensities, which occur as a result of propagation through a layer, the weights of the SNNs and due to the mathematical nature of competition rules; ultimately making a signal instance to cause spikes in later layers extremely challenging. This example overcomes this challenge by proposing a dynamical framework that endows waves in the preceding layers with the ability to trigger input signals that initiate autonomous waves in subsequent layers. Triggering activity waves in subsequent layers (instead of independent, individual spikes) allows the network to establish an organized firing pattern throughout the network, in essence amplifying the signal received from the lower layers and passing information to higher layers without requiring additional transformation modules.

### 3 Modular SNN Tool-kit: Dynamical Systems Framework

In order to build a scalable multi-layer SNN, this example describes a dynamical systems framework for the self-organization algorithm. The framework utilizes the following key concepts of (i) emergent spatiotemporal waves of firing neurons, (ii) dynamic learning rules for updating inter-layer weights and (iii) non-linear activation and input/output competition rules between layers to build a modular spiking sub-structure. The modular spiking sub-structure can be stacked to form multi-layered SNNs with an arbitrary number of layers (e.g., 4, 5, 6, 7, 8, 9, 10, 20, 30, 40, 50, 60, 70, 80, 90, 100 or more) that self-organize into a wide variety of connectivity architectures. The following sections describe the tool-kit that can be used to build a single module that can be seamlessly stacked to self-organize multi-layer SNN architectures. The sections describe the framework by discussing the SNN model that generates waves and the learning/competition rules that achieve inter-layer connectivity.

### 3.1 Governing Equations of “Neuronal Waves”

One building block for SNNs is a spiking neuron model that describes the state of every single neuron over time, often represented by a dynamical system. This example uses a modified version of the Leaky-Integrate-and-Fire (LIF) model with an additional adjacency matrix term and input term (from preceding layers), coupled with a dynamical threshold equation. The vectorized governing equations for each layer [symbol] reads

$$\frac{d}{dt} v = - \frac{1}{{τ}_{v}} v + S ℋ ( v - θ ) + {S}^{x} x \\ \frac{d}{dt} θ = \frac{1}{{τ}_{θ}} ( {v}^{t h} - θ ) ⊙ ( 1 - ℋ ( v - θ ) ) + {θ}^{+} ℋ ( v - θ ) \qquad [ 2.1 ]$$

where v is the voltage, θ is the variable firing threshold, x is the input signal to this layer, [symbol] is the (element-wise) heavy-side function and ⊙ denotes the Hadamard product. S is the intra-layer adjacency matrix and S^{x} is the spike input matrix. All vectors and matrices are elements of [symbol] ⁿ^{ₗ} and [symbol] ⁿ^{ₗ}^{×n}^{ₗ} respectively, where nₗ is the number of neurons in layer l. A neuron i fires a spike when its voltage vᵢ exceeds its threshold θᵢ. After firing, the neuron's voltage is reset to v^{reset}. The dynamic threshold equation for θ is governed by a homoeostasis mechanism to ensure that no neuron can spike excessively. Concretely, θ increases by a rate θ⁺ whenever a neuron is spiking, until θ exceeds v and the neuron fires no more. Then θ decays exponentially to a default threshold v^{th}. All additional hyper-parameters are summarized in the Supplemental Information section of this example.

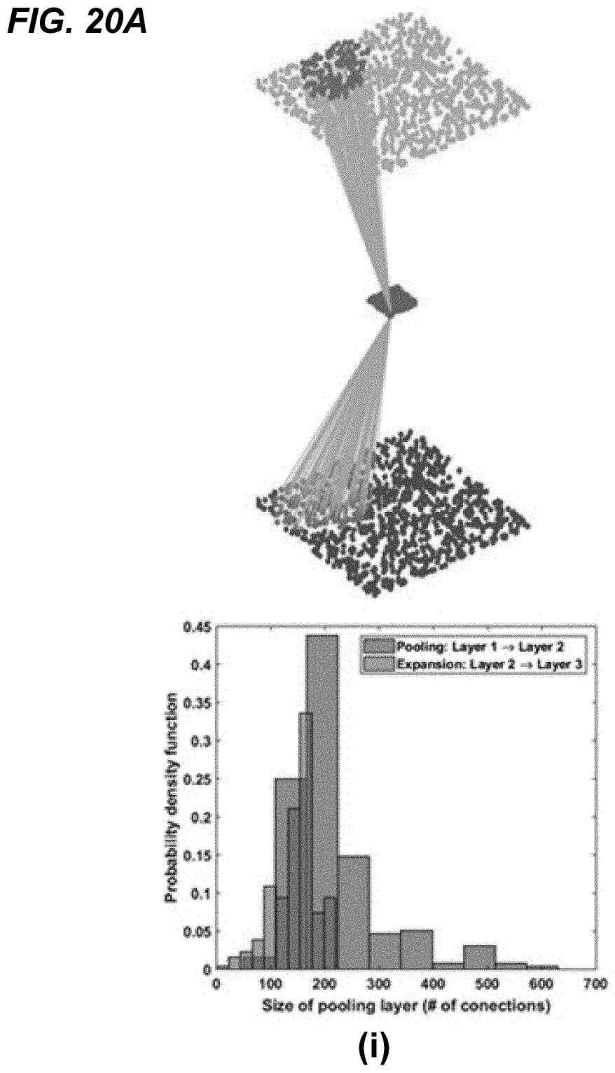

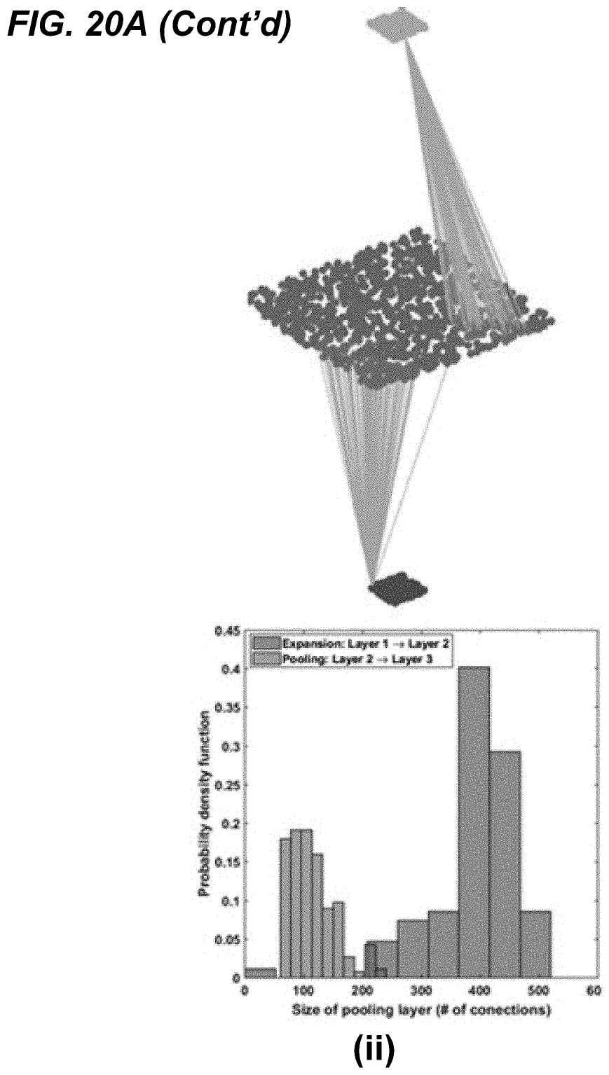

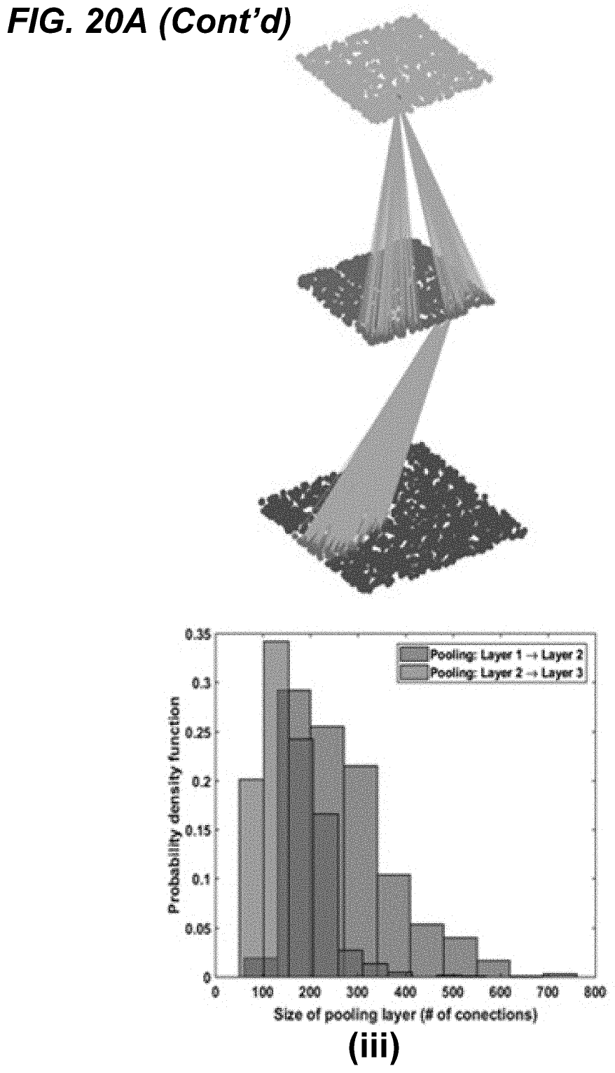

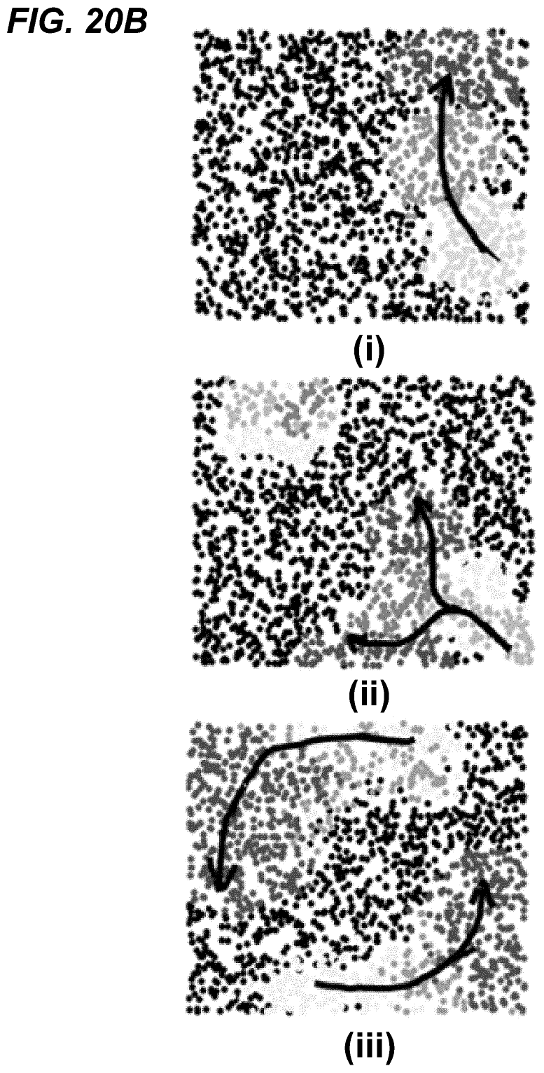

S∈ [symbol] ⁿ^{ₗ}^{×n}^{ₗ} encodes the spatial-connectivity of neurons within the layer (that can have arbitrary geometry) and is biologically inspired. The intra-layer connectivity can generate spatiotemporal wave states in both 1D and 2D geometries of connected spiking neurons as shown in Example 1. In the multi-layer SNN, S [symbol] (v−θ) serves as a back-coupling term, crucial for the development of coherent wave dynamics in subsequent layers. The optional spike-input matrix S^{x}∈ [symbol] ⁿ^{ₗ}^{×n}^{ₗ} can be used to further control the input received from preceding layers. The geometry of the layer and an isotropic kernel with a tunable excitation and inhibition radius and amplitude factors are encoded into S. The kernel leads to positive intra-layer neuronal connectivity inside the excitation radius rⁱ and decaying negative connections outside the inhibition radius r^{o}. Concretely, the adjacency matrix with kernel is given by

$${S}_{i , j} = \{ \begin{matrix}{a}^{i} , & {D}_{i , j} < {r}^{i} \\ - {a}^{o} {e}^{( - {D}_{i , j} / 10 )} , & {D}_{i , j} > {r}^{o}\end{matrix} \qquad [ 2.2 ]$$

where D_{i,j}∈ [symbol] ⁿ^{ₗ}^{×n}^{ₗ} is the matrix of spatial distances between each neuron and aⁱ/a^{o} are the excitation and inhibition amplitude factors. One can now vary the kernel radii and other hyper-parameters to control the emergent wave properties and obtain an array of wave phenomena with interesting shapes and dynamics. A few exemplary wave regimes are depicted in FIG. 20B.

### 3.2 Learning Rules

Having constructed a spontaneous spatiotemporal wave generator across multiple layers in the previous section, a local STDP learning rule is implemented to update inter-layer connectivity based on the patterns of the emergent waves, in order to self-organize SNNs into a wide variety of architectures. STDP potentiates connections between neurons that spike within a short interval to each other and provides lower updates for those neurons that have distant spike-times. As an example STDP rule, the Hebbian rule can be used to only link the synchronous pre- and post-synaptic firings of neurons for the dynamic update of weights between the two connected layers. There are many types of sophisticated STDP rules such as additive STDP or triplet STDP. The learning rule can be integrated into the dynamical system as the dynamical matrix equation:

$$\frac{d}{d t} {W}^{( {l}_{1} )} = η ( {y}^{( {l}_{1} )} ⊗ {y}^{( {l}_{2} )} ) \qquad [ 2.3 ]$$

where η is the learning rate y^{(l}^{₁}⁾∈ [symbol] and y^{(l}^{₂}⁾∈ [symbol] denote the spiking output signals of the two layers that W^{(l}^{₁}⁾∈ [symbol] connects, and ⊗ is the outer product of the two vectors. The specific variables coupled in equation 2.3 can be customized to achieve various desired connectivity architectures.

### 3.3 Competition Rules

In addition to the learning rules, various “competition rules” on the layer inputs and outputs can be used to further localize connections with different strengths, to form pooling architectures. For instance, by coupling the spiking outputs in equation 2.3 with y^{(l}^{₂}⁾ filtered by a “winner-take-all” competition rule, the formation of pools from l₁ to the maximum spiking neuron in l₂ can be enforced. An input spike signal x can similarly be filtered. The winner-take-all competition rule for a vector x reads:

$${f}^{𝒞} ( x ) : \{ \begin{matrix}{x}_{i} = 0 , & ∀ {x}_{i} < max ( x ) \\ {x}_{i} = max ( x ) , & otherwise .\end{matrix} \qquad [ 2.4 ]$$

The competition rule f^{c} works on each neuron i within a layer 1. From equation 2.4, many variations like “k-best-performers” and other competition rules can be derived and applied to achieve pools of different shapes and weightings throughout the layers. 3.4 Multi-layer SNN Learning Algorithm

With the three building blocks (equations 2.1, 2.3, and 2.4) established, the algorithmic flow of an input signal x⁽¹⁾ of a layer (lᵢ=1) to the input x⁽²⁾ of the next layer (1₂=2) is elaborated in algorithm 2.1. In algorithm 2.1 LIFO stands shorthand for a time-1) (integration pass through equation 1 and [symbol] _{v,θ}⁽¹⁾ is the respective spike vector. Furthermore, [symbol] and [symbol] are the (optional) competition rules for the output of l₁ and input to l₂ respectively and g(⋅) denotes the activation function of the layer, which is a rectified linear unit (ReLU) in one embodiment. As can be seen, the entire algorithm is model-able as a large dynamical system coupling the wave dynamics equations of individual layers with the weight dynamics equations given by STDP learning rules between the layers. All equations can be integrated in time at the same time-level by using a Runge-Kutta-4 time-stepping scheme for numerical integration.

Algorithm 2.1. Multi-layer SNN dynamical system.

Input: Signal x⁽¹⁾ (t) as input to input layer l = 1.
Output: Weights W^{(l)} (t) & spiking outputs y^{(l)} (t) for all layers l ≥ 1.
for t = 1 . . . Nₜ in Δt time-steps do
| for l = 1 . . . Nₗ in layers do

| | |
|---|---|
| \| \| [symbol] _{υ,θ}^{(l)} [symbol] LIF^{(l)} (x^{(l)}, Δt) | integrate input with LIF by Δt |
| \| \| y^{(l)} [symbol] f^{C}^{_{y}}^{^{(l)}}( [symbol] _{υ,θ}^{(l)}) | apply output competition rule to spikes |

| | if l ≥ 2 then
| | | W^{(l-1)} [symbol] LR^{(l-1)}(y^{(l-1)}, y^{(l)}, Δt) integrate learning rule of preceding weights
| | end

| | |
|---|---|
| \| \| z^{(l+1)} [symbol] W^{(l)}y^{(l)} | multiply local weights to output signal |
| \| \| a^{(l+1)} [symbol] g(z^{(l+1)}) | apply activation function |
| \| \| x^{(l+1)} [symbol] f^{C}^{ₓ}^{^{(l+1)}}(a^{(l+1)}) | apply input competition rule to obtain signal for next layer |

| end
end

Self-organizing Multi-layer Spiking Neural Networks

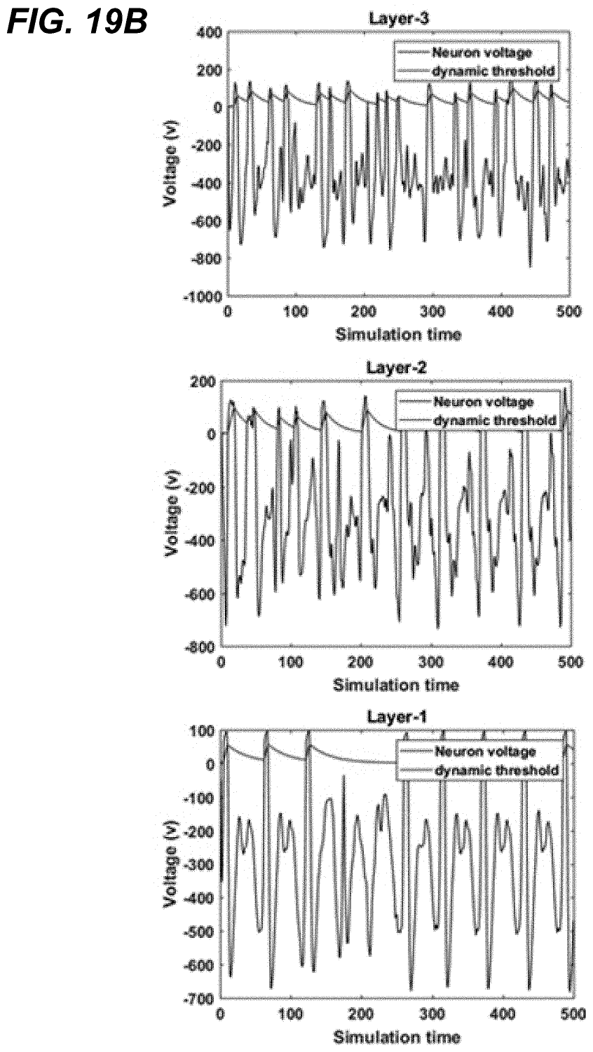

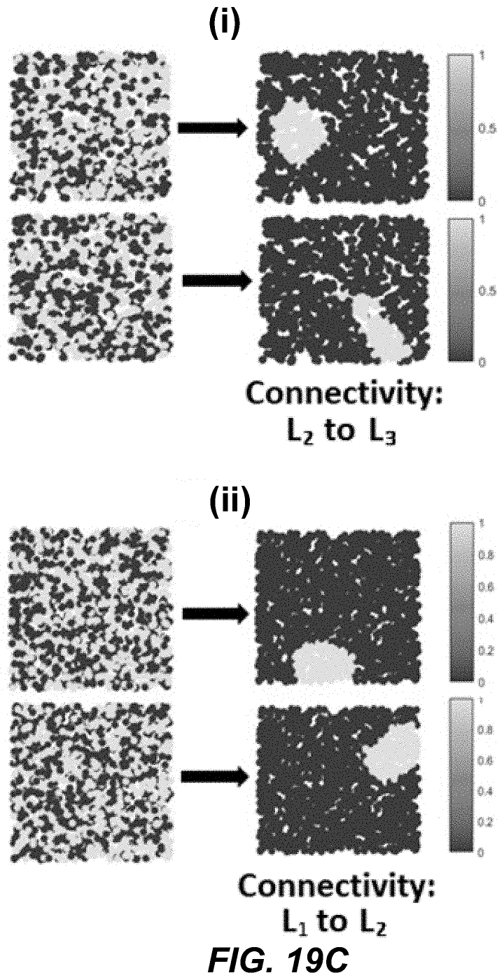

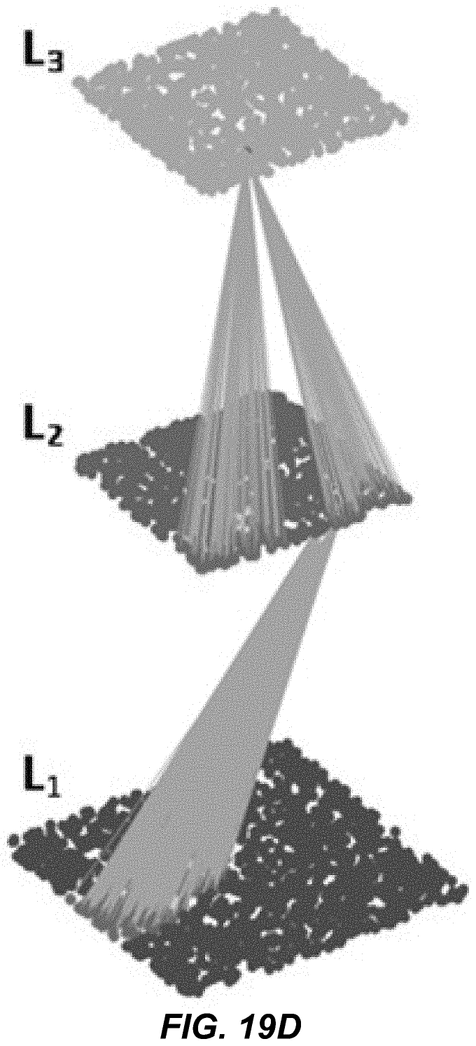

The modular tool-kit introduced in the previous section enables the efficient, autonomous self-organization of large multi-layer SNNs. The key ingredients required for self-organization are (i) traveling waves that emerge simultaneously across multiple layers and (ii) a dynamic learning rule that tunes the connectivity between any two layers based on the properties of the waves tiling the layers. This example demonstrates the entire self-organization process in FIGS. 19A-19D (moving from left to right). The two major components of the self-organization process are elaborated in the following subsections.

### 4.1 Emergent Activity Waves in Multiple Layers

Stochastic communication between spiking neurons in layer-1 arranged in a local-excitation, global inhibition connectivity leads to the emergence of spontaneous traveling activity waves within the layer. The waves in layer-1 trigger waves in layer-2 that subsequently initiates waves in layer-3. The traveling waves across the 3 layers are depicted in FIG. 19A. The algorithm enables the motion of waves in higher layers without the need for a constant stimulation from the lower layers. In other words, the wave activity in higher layers, once triggered, can ‘stay alive’ even if there is no spiking activity in the lower layers. Another key property of the traveling waves in the higher layers is that the traveling waves have their own autonomy/‘curiosity’ to explore different regions within the layer. The level of ‘curiosity’ is dependent on the input from the preceding layer and the strength of intra-layer connectivity, which force the wave to not arbitrarily stray away from the source of the input-signal.

Waves in any layer are observed primarily due to the spiking dynamics of individual neurons. FIG. 19B shows the voltage trace of one neuron within each layer along with its spiking threshold. A neuron fires only when its voltage surpasses the spiking threshold, and the spiking frequency within each layer governs the dynamics of the activity wave.

### 4.2 Local Learning Rules Leads to Self-Organization

The activity waves generated in each layer serve as a signal to modify the inter-layer weights. Along with the ‘signal’, local learning rules update inter-layer connections. Here, Hebbian-based STDP rules (described in section 3.2 of this example) coupled with competition rules (described in section 3.3 of this example) can be used to update inter-layer weights. FIG. 19C depicts the simultaneous activity-wave driven self-organization across multiple layers. The connectivity between the layers go from a random configuration to pooling structures between the layers, guided by the dynamics of the activity wave. A final self-organized multi-layer spiking network is rendered in 3D in FIG. 19D.

FIGS. 19A-19D. Self-organizing multi-layer spiking neural networks. FIG. 19A. Emergent spatiotemporal waves in L₁ trigger neuronal waves in higher layers (L₂, L₃). Black nodes indicate the neuron positions within a layer and shades of red depict firing nodes. The lighter red represents nodes that fired at an earlier time-point. Lighter red to dark red captures the motion of the waves on each layer. FIG. 19B. Tracking the voltage v of a single neuron in each layer over time. The neuron ‘fires’ when the v crosses its dynamic threshold (blue line). FIG. 19C. Self-organization process transforms a randomly wired inter-layer connectivity (left of the arrow) to a pooling architecture (right), wherein units in higher layers (L₂, L₃) are connected to a spatial patch of nodes in its preceding layer. Each subplot displays the connectivity of a single unit in a higher layer to all units in the preceding layer. Yellow/blue represent regions with/without presence of connections. Connectivity of 4 units each in L₃ and L₂ are depicted in FIG. 19C panels i and ii respectively. FIG. 19D. 3D rendering of the final self-organized architecture.

### 5 Flexibility Enabled by the Dynamical Systems Framework

The framework established in the previous section is the first demonstration of autonomous self-organization of a multi-layer spiking network, without the need for any additional transformation modules to connect subsequent layers.

This section demonstrates that designing the modular tool-kit in a dynamical systems framework endows the system with flexible features. The modular construction of different layers allows tuning the emergent wave dynamics on each layer, ultimately resulting in different self-organized architectures. The wave dynamics in each layer can be tuned by varying (i) excitation/inhibition connectivity (rⁱ, r^{o}) between neurons within every layer and (ii) by altering the time-constants and other hyper-parameters governing the spiking dynamics of neurons in each layer. FIG. 20B portrays a broad range of wave dynamics achievable on the layers of the network.

Along with varying wave dynamics, modifying the size and shape of waves across different layers, and the number of nodes in each layer, the algorithm can self-organize a wide variety of multi-layer NN architectures (FIGS. 20A-20B). FIG. 20A demonstrate efficient self-organization of three common neural architectures: (panel i) (Self-organized autoencoder) Pooling followed by expansion, (panel ii) Expansion followed by a pooling layer, (panel iii) Consecutive pooling operations (Self-organized retinotopic pooling structure). The histograms in FIG. 20A capture the size of the self-organized pooling and expansion structures between the layers. The size of a pooling structure from L₁→L₂ is the number of connections a single node in L₂ makes with nodes in L₁, while the size of the expansion structure from L₂→L₃ is the number of connections a single node in L₂ makes with nodes in L₃. As the pooling and expansion structures follow a sharp uni-modal distribution, it can be inferred that the algorithm imposes a tight control over the size of the self-organized structures.

FIGS. 20A-20B. Flexibility of the framework. FIG. 20A. Self-organizing a variety of neural architectures: (panel i) Pooling followed by expansion (autoencoder) (panel ii) Expansion followed by pooling, (panel iii) Consecutive pooling structures. Histograms capture the sizes of emergent pooling and expansion structures in the self-organized network. FIG. 20B. Regimes of wave dynamics: (panel i) Stable single wave, (panel ii) Unstable splitting and merging waves, (panel iii) Stable periodically rotating fluid-like wave.

### 6 Functionality: Real-Time Unsupervised Feature Extraction

The previous section demonstrates that spiking networks can be self-organized into a wide variety of architectures. This section shows that these networks are functional. In an assessment of semi-supervised classification on MNIST, a linear classifier (which is appended to the end of an SNN self-organized by noise) is trained without modifying SNN weights by back-propagation. The train/test accuracy was consistent across multiple 3-layered SNNs averaging at 96.5%/93%.

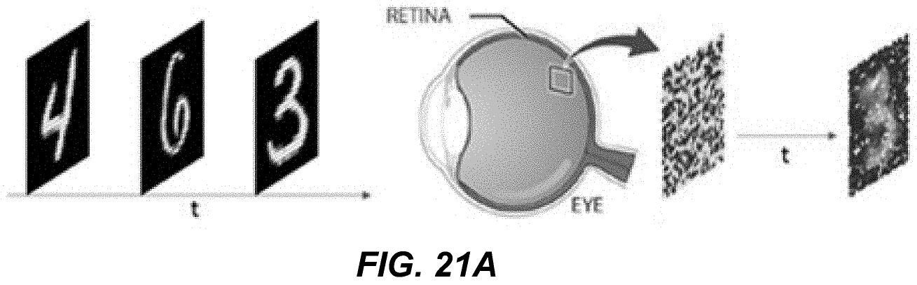

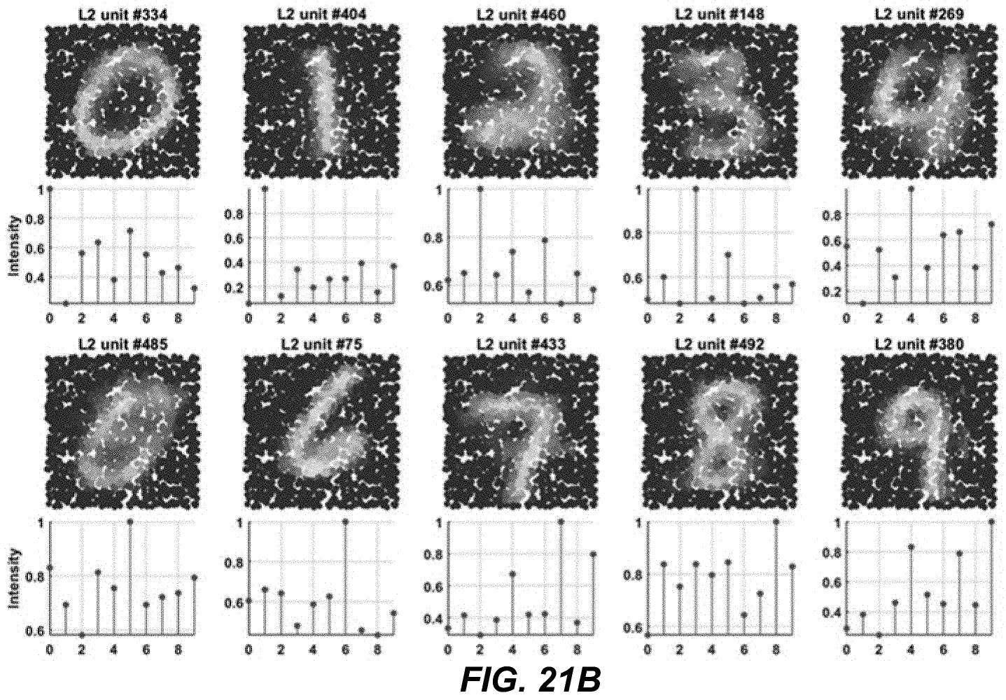

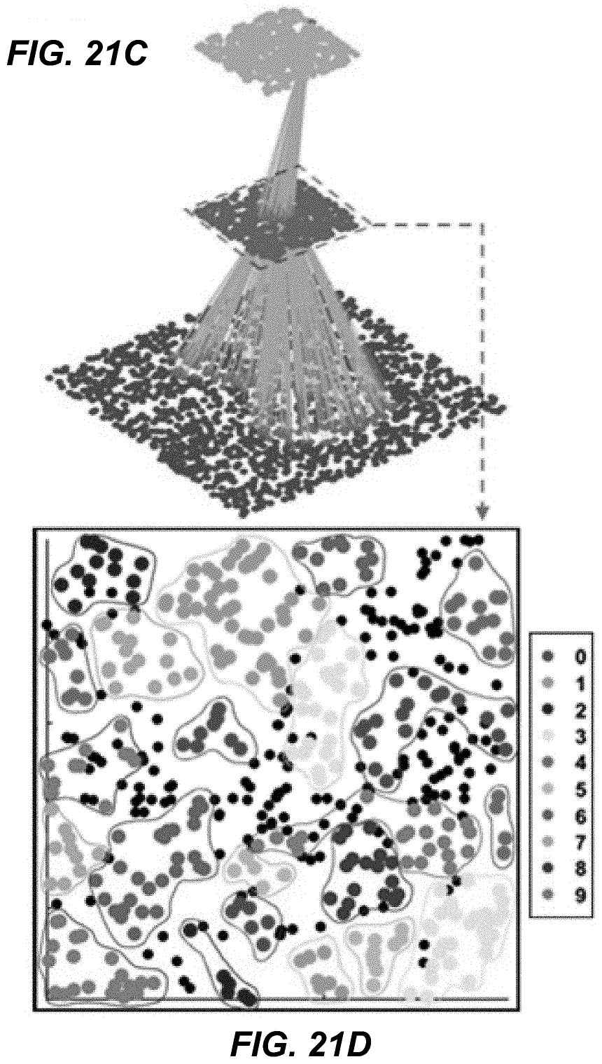

For the task of unsupervised feature extraction, a stream of images is feed as input to the algorithm in real-time, with a frame rate of one image every 5 seconds, while time-integrating the multi-layered SNN (FIGS. 21A-21D). As a structured image-input is available, the parameter regime for the input layer (L₁) is chosen to ensure that noisy clusters of firing neurons shape like the input image (here, MNIST digits) with spatiotemporal oscillations appear. Although there are no activity waves in L₁, waves can still emerge in the subsequent layers.

The local learning rules coupled with competition rules enable many L₂ neurons to extract features from the input image (MNIST digits). Also, certain L₂ units specialize on a single class of MNIST digits. The specialization of L₂ units for a single class of MNIST digits is clearly observed by visualizing its self-organized connectivity to the input-layer and its tuning curves, both depicted in FIG. 21B. The tuning curve for an L₂ unit is generated by feeding 10 classes of MNIST digits to the network and recording its spiking intensity. For instance, in FIG. 21B, L₂ unit #404 has a connectivity to the input-layer that resembles MNIST digit ‘1’ and its tuning curve (plotted below) confirms that L₂ unit #404 maximally spikes when MNIST digits of class ‘1’ are fed as input. Another interesting feature of the self-organization algorithm is that the neurons in L₂ that specialize for certain classes of MNIST digits, also spatially cluster within the layer. The spatial clustering of L₂ units for different MNIST classes are shown in FIG. 21D. The different node-colors correspond to neurons in L₂ that specialize to different MNIST classes. The spatial clustering of input-classes in L₂ is a direct consequence of the emergent spatiotemporal waves in L₂. Since the inter-layer connectivity is randomly initialized (mean: μ=1, std. dev. σ=0.5) at t=0, even if a learning rule enables the learning and increases specialization of certain L₂ units, the formation of any type of spatial clustering of input-classes is not expected, i.e. the distribution of specialized neurons would be arbitrary, if it was not for the wave. The spatiotemporal wave in L₂ enables the formation of spatially coherent connections that proceed to become specialized coherent learning structures within L₂.

FIGS. 21A-21D. Unsupervised learning of self-organized networks. FIG. 21A. Schematic of bio-inspired real-time learning: a 3-layered SNN learns on 2000 images, while being forward-integrated in time; the SNN tests on circa 8000 images. FIG. 21B. Unsupervised feature extraction forms pools that resemble MNIST digits: W⁽¹⁾ weights of 10 exemplary L₂ neurons connecting to displayed L₁ neurons that form pools in shapes of digits. The respective tuning curves of each L₂ unit shows the (0-1-scaled) mean output spike intensities to input spikes of all kinds of digits in the test set demonstrating the specialized L₂ unit spiking most intensely for one specific digit. FIG. 21C. Exemplary connectivity pattern of the 3-layered network: pooling connection in shape of an ‘8’. FIG. 21D. Coherent learning clusters in the L₂ that each, as a local group, specialize on learning/classifying a certain class of input digit.

### 7 Discussion

This example addresses an important question of how large artificial computational machines could build and organize themselves autonomously without any involved human intervention. Currently, architectures of artificial systems are obtained after hours of painstaking hand parameter tuning. Inspired by the growth and self-organization of complex architectures in the brain, the example introduces a dynamical systems framework to utilize emergent spatiotemporal activity waves to autonomously self-organize a multi-layer spiking neural network into a wide variety of architectures.

The work has shed light on the importance of spatiotemporal neural computation. Most ANNs and their training algorithms do not take into account the spatial positions of their constituent ‘neurons’ (computational units). Here, SNNs are built out of neurons with a distribution in 3D space relevant to the computation. The spatial relationship between constituent neurons is enforced by adjacency matrices, which leads to biologically relevant phenomena like propagating neuronal activity waves and spatial clustering of units in higher layers that specialize for different classes of inputs. As emergent neuronal waves in the layer are key biological phenomena, spatial connectivity can be considered to build systems that are more ‘brain-like’.

The spatial clustering of functionality in the biological brain and the presence of spontaneous neuronal activity waves spanning the entire brain during development, suggests that the bio-inspired learning algorithm is an effective direction for the development of computational neuroscience models and bio-inspired machine-learning tools.

### 8 Impact

AI has grown by leaps and bounds over the last decade and has become ubiquitous across a large number of industries. AI and neural networks have been implemented for real-time decision making in self-driving cars, have enabled data-driven diagnosis in hospitals and have enhanced the comforts at home by effectively being integrated into household appliances via IoT sensors.

Although AI technology and neural networks are being actively incorporated in multiple industries to perform a wide range of tasks, discovering the right architecture for a particular task/application continues to remain an ordeal. In scenarios, where effective neural network architectures have been discovered, the architectures remain rigid to changes in input-size and might require a lot of pre-processing of the raw input before they can be fed to the network. Also, current methods for building neural networks are not suited for the flexible addition or removal of concurrent data streams.

For example, mass produced camera technology that provides real-time data feeds from distributed cameras and drones deployed across the world can be simultaneously processed by neural networks to monitor climate change, agriculture, disaster prone regions and to assist policy makers and society planners to refine current practices.

To do so, neural networks that can simultaneously process multiple image data-streams and subsequently make intelligent decisions can be constructed. Conventionally, neural network architectures are hand-designed to process concurrent feed from distributed cameras, based on the following parameters: (i) number of data-streams (# of input-cameras), (ii) data structure (# of pixels), (iii) the input frame-rate (# of images captured per second) to name a few. The current network architecture cannot autonomously adapt itself to the addition of new data-streams (new camera installations), or to updates in the data resolution, or to changes to the data-sampling rate. The lack of flexibility forces an engineer (or an AI resource provider) to constantly hand-tune and update their networks for inevitable changes to the camera-sensor network!

This example illustrates a novel algorithm (or paradigm) to wire large neural networks. Inspired by wiring of neural circuits in the growing brain of an infant, the algorithm can autonomously self-organize the connectivity of artificial neural networks. Wiring of networks via self-organization endows networks with the additional flexibility to quickly adapt to changes in the input ‘structure’, changes in the number of input data-streams, eliminating the requirement of human intervention!

Also, as the algorithm is well-suited for networks built out of spiking units, flexible self-organization of networks can be directly implemented on neuromorphic hardware. Neuromorphic hardware has recently gained a lot of traction for their low-power consumption, reduced latency and their on-chip learning functionality (unlike edge devices that can only perform inference).

### Supplemental Materials

### 9 Modular SNN Tool-Kit: Dynamical Systems Framework

### 9.1 Governing Equations of “Neuronal Waves”

### Linear Integrate and Fire (LIF) & Dynamic Threshold Neuron Model:

$$\frac{d}{d t} v = \frac{1}{{τ}_{v}} ( - v + S ℋ ( v - θ ) + {S}^{x} x ) \\ \frac{d}{d t} θ = \frac{1}{{τ}_{θ}} ( {v}^{t h} - θ ) ⊙ ( 1 - ℋ ( v - θ ) ) + {θ}^{+} ℋ ( v - θ ) \qquad [ 2.5 ]$$

where:
v is the voltage
θ is the variable firing threshold
x is the input signal to this layer
[symbol] is the (element-wise) heavy-side function
⊙ denotes the Hadamard product
S is the intra-layer adjacency matrix
S^{x} is the spike input matrix
   All vectors and matrices are elements of [symbol] ⁿ^{ₗ} and [symbol] ⁿ^{ₗ}^{×n}^{ₗ} respectively, where nₗ is the number of neurons in layer l.
   9.2 Intra-Layer Connectivity of Neurons within a Layer

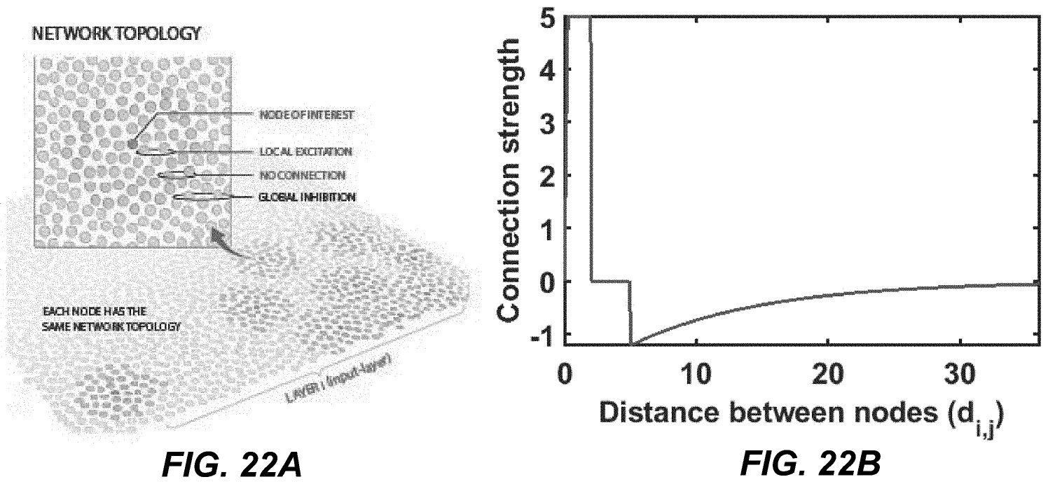

The nodes in all the layers are arranged in a local-excitation, global inhibition topology, with a ring of nodes that have neither excitation or inhibition (zero weights) between the excitation and inhibition regions. This ring of no connections between the excitation and inhibition regions gives a good handle over the emergent wave size. This is detailed in section 9.2.1 and depicted in FIGS. 22A-22B.

### 9.2.1 Intra-Layer Connectivity & Kernel

This kernel is pictorially depicted in FIGS. 22A-22B and mathematically given by

$${S}_{i , j} = \{ \begin{matrix}{a}^{i} , & {D}_{i , j} < {r}^{i} \\ - {a}^{o} {e}^{( - {D}_{i , j} / 10 )} , & {D}_{i , j} > {r}^{o}\end{matrix} \qquad [ 2.6 ]$$

where: S_{i,j}∈ [symbol] ⁿ^{ₗ}^{×n}^{ₗ} is the adjacency weight between neurons i and j, D_{i,j}∈ [symbol] ⁿ^{ₗ}^{×n}^{ₗ} is the Euclidean distance between neurons i and j, rⁱ is the local excitation radius, r^{o} is the global inhibition radius (all nodes present outside this radius are inhibited), aⁱ is the amplitude factor of excitation, a^{o} is the amplitude factor of inhibition.

The spike input matrix S^{x} can be chosen with a similar or a different structure, however, it can contain an identity diagonal that accounts for the spikes itself (unlike the adjacency matrix S which does not have a diagonal, since the distance from any neuron to itself is 0).

FIGS. 22A-22B. Connectivity kernel of intra-layer connections: Every neuron is connected to other neurons in the layer within a radius rⁱ via a positive weight, not connected to nodes positioned at a distance between rⁱ and r^{o} and connected to nodes at a distance larger than r^{o} with a decaying negative weight.

### 9.3 Learning Rules and Competition Rules

Local learning rules

$$\frac{d}{d t} {W}^{( {l}_{1} )} = η ( {y}^{( {l}_{1} )} ⊗ {y}^{( {l}_{2} )} ) \qquad [ 2.7 ]$$

where:
η is the learning rate
y^{(l}^{₁}⁾∈ [symbol] and y^{(l}^{₂}⁾∈ [symbol] denote the spiking output signals of the two layers
W^{(l}^{₁}⁾∈ [symbol] connects layer l₁ and l₂ and
⊗ is the outer product

Competition rules

$${f}^{𝒞} ( x ) : \{ \begin{matrix}{x}_{i} = 0 , & ∀ {x}_{i} < max ( x ) \\ {x}_{i} = max ( x ) , & otherwise .\end{matrix} \qquad [ 2.8 ]$$

The competition rule f^{C} (winner-take-all is depicted) works on each neuron i within a layer l. Many variations like “k-best-performers” and others can be derived from equation 2.7, and applied to achieve pools of different shapes and weightings throughout the layers.

Additional to the weight update through the learning rule, a range normalization can be performed on each updated column i to a range of 10 by

$${W}_{: , i} ↤ 10 \frac{{W}_{: , i}}{max ( {W}_{: , i} ) - min ( {W}_{: , i} )} \qquad [ 2.9 ]$$

so that the magnitude of specific weight updates cannot grow without bounds. This also eliminates the chances of initialized bias (artifacts of the random initialization of W) to cause increasingly larger bias and leads to a natural decay of weights that are connected to neuron pairs with no firing correlation.

Lastly, an input threshold β′∈ [symbol] ⁿ^{ₗ} Pell for the input x can be evolved by

$$\frac{d}{d t} β = 0.01 x \qquad [ 2.10 ]$$

and subtracted before activation x= [symbol] (g(Wy−β)). This has a regularizing effect by slowly penalizing neurons with a history of receiving high inputs x frequently.

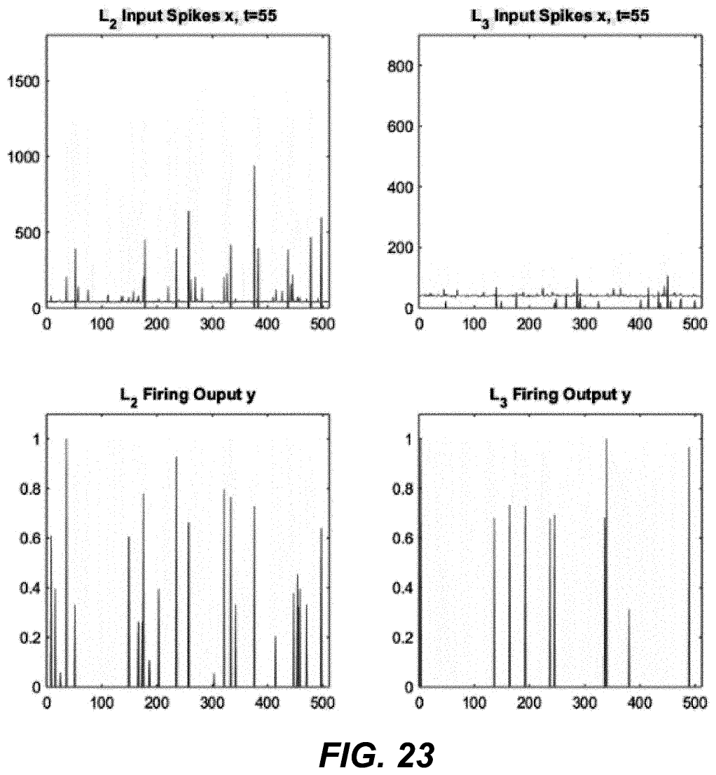

FIG. 23 (and the video at https://drive.google.com/file/d/14yW_cBZAj8fPpueTvBMm7siUcfvWvUBU, which is incorporated herein by reference in its entirety) shows spiking input x and response y of neurons across layers 2 & 3 (real-time) at. The input threshold β^{x} is depicted in orange.

### 10 Self-Organizing Multi-Layer Spiking Neural Networks

### 10.1 Emergent Activity Waves in Multiple Layers

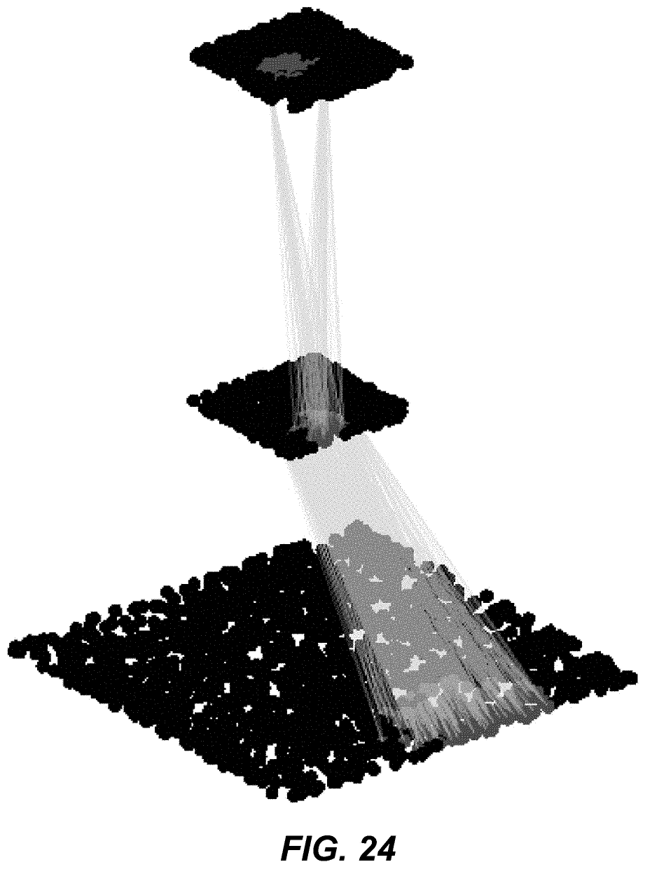

The dynamical systems framework enables simultaneous waves in multiple layers of the network. A 3D rendering of traveling activity waves across multiple layers is shown in FIG. 24 (and the video at https://drive.google.com/file/d/1qDTarhWCNkAQp4LXBPnT5Qm9PusCPWkq, which is incorporated herein by reference in its entirety). https://drive.google.com/file/d/1qDTarhWCNkAQp5LXBPnT5Qm9PusCPWkq/view?usp=sharing sp=sharing

### 10.2 Local Learning Rules Leads to Self-Organization

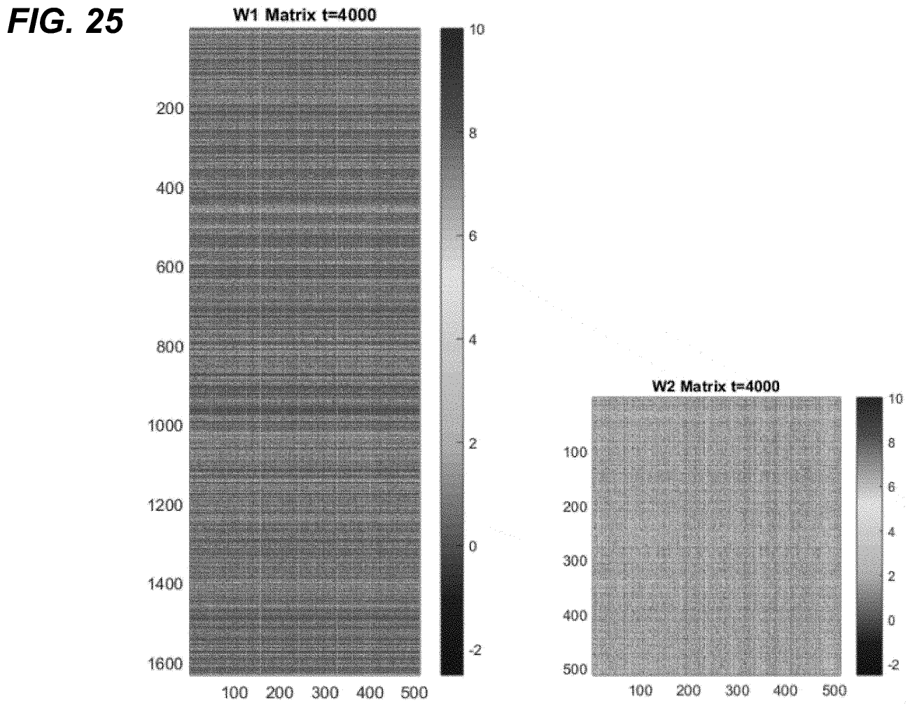

The dynamical matrix in equation 2.7 evolves the inter-layer weight matrices connecting neurons of different layers. FIG. 25. W₁ https://shorturl.at/opK39 and W₂ inter-layer connectivity evolves over time. The figure shows development of structured sparsity of the randomly initialized matrix, through self organization.

### 11 Flexibility Enabled by the Dynamical Systems Framework

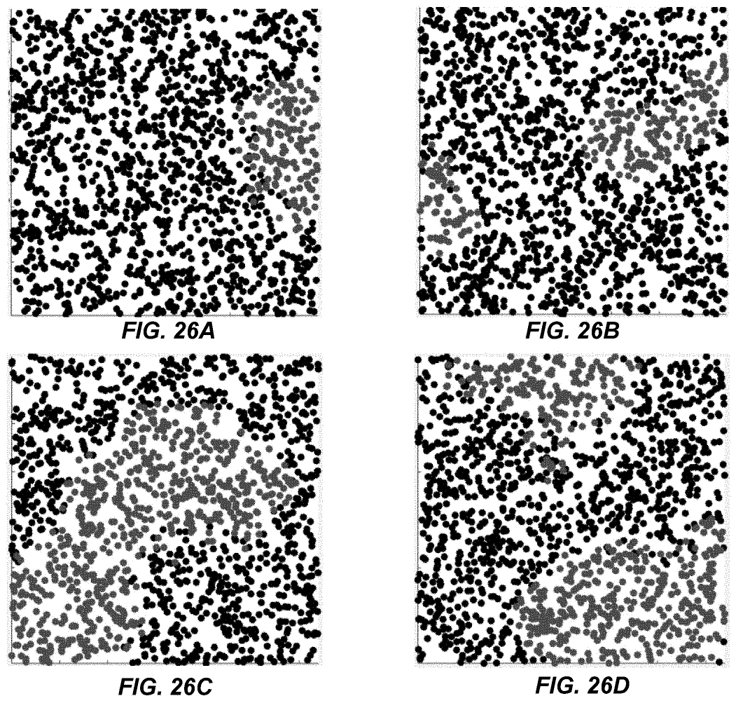

FIGS. 26A-26D show three different kinds of wave regimes with interesting, rich dynamics. As hyper-parameter settings are varied, the following are obtained:
a stable single wave regime (FIG. 26A and the video at https://drive.google.com/file/d/1v-MUmHxXAhCXATnnq8Kw8vVqT4g5Z4jT, the content of which is incorporated herein by reference in its entirety)

an unstable splitting-merging wave regime (FIG. 26B)

a periodic fluid-like wave regime with (1) colliding behavior (FIG. 26C and the video at https://drive.google.com/file/d/1P26CRX-LGGnG29Siv89RvxocOXOdRY2, the content of which is incorporated herein by reference in its entirety) or (2) rotating behavior (FIG. 26D and the video at https://drive.google.com/file/d/1ufJAt2tet2YoeU1E2FWcqHh21k-Sw-4y, the content of which is incorporated herein by reference in its entirety).

Reference parameter settings for achieving those different wave behaviors are given in Table 2.1.

TABLE 2.1
Hyper-parameters of the spatiotemporal wave with approximate
reference values for: (I) the typical stable single
wave, (II) unstable splitting-merging wave, (III) periodic
fluid-like wave regime in a 2D square domain.

| Hyper- | | | | | |
|---|---|---|---|---|---|
| param. | | | | | |
| type: | Description: | I: | II: | III: | Unit |
| Time | | | | | |
| dynamics | | | | | |
| τ_{ν} | Time constant of ν | 1 | 0.5 | 0.5 | ms |
| τ_{θ} | Time constant of θ | 30 | 10 | 10 | ms |
| θ⁺ | Rate of increase | 10 | 6 | 6 | ms⁻¹ |
| | of θ | | | | |
| ν^{th} | Default resting | 1 | 1 | 1 | mv |
| | voltage for θ | | | | |
| ν^{reset} | Voltage reset value | 0.1 | 0.1 | 0.1 | mv |
| | for ν | | | | |
| Spatial | | | | | |
| dynamics | | | | | |
| rᵢ/rₒ | Excitation/ | 3/6 | 2/4 | 2.5/10 | mm |
| | Inhibition radius | | | | |
| aᵢ/aₒ | Excitation/ | 30/−10 | 45/−3 | 30/−1 | (μms)⁻¹ |
| | Inhibition factor | | | | |
| Domain | | | | | |
| L | Characteristic length | 28 | 32 | 32 | mm |
| | of layer | | | | |
| nₗ/Aₗ | Neuron density of | 2-5 | 1.5-4 | 1.5-4 | 1/mm² |
| | layer | | | | |

### 12 Functionality: Real-Time Unsupervised Feature Extraction

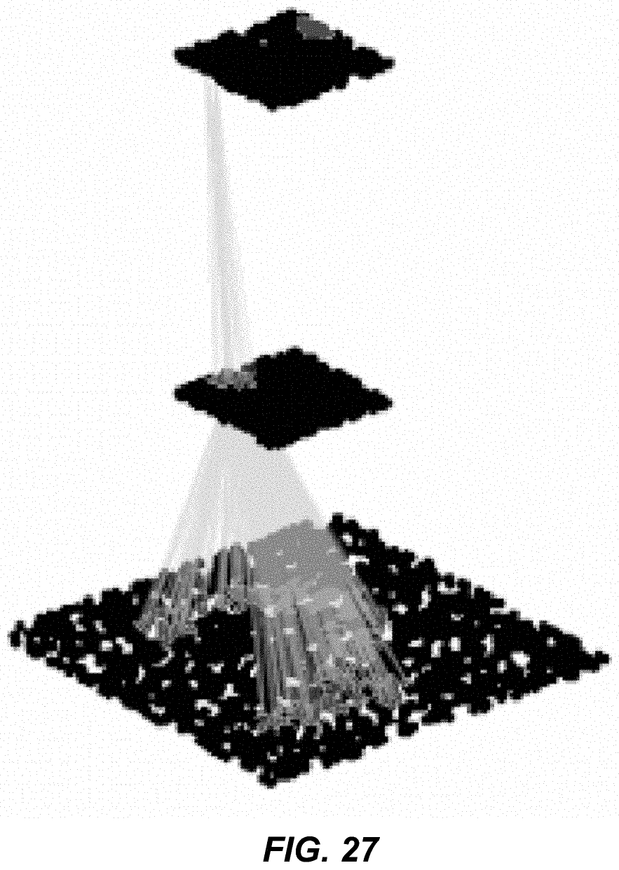

As MNIST digits are being fed to the network at real-time, local-learning rules coupled with emergent waves across multiple layers self-organize the multi-layer SNN to form spatially clustered specialized neurons in the higher layers to certain classes of inputs (different MNIST digit classes). FIG. 27 (and the video at https://drive.google.com/file/d/1DAbv4goCRks8cjdztrIP1CP0tizqGFag, the content of which is incorporated herein by reference in its entirety) shows the self-organization of a 3 layer SNN when fed MNIST digits in real-time. FIG. 27. The network self-organizing its connections while “seeing” MNIST digits.

### 13 Traveling Waves

### 13.1 Arranging Sensor-Nodes in a Line

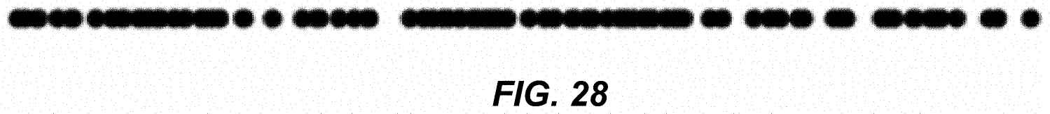

A configuration where N sensor-nodes are randomly arranged in a line is chosen (FIG. 28).

The activity of N sensor nodes, arranged in a line as in FIG. 28, are modeled using an ODE system resembling a simpler LIF model as described below:

$${τ}_{d} \frac{d v ( {x}_{i ,} t )}{d t} = - v ( {x}_{i} , t ) + {Σ}_{{x}_{j} ∈ 𝒳} S ( {x}_{i} , {x}_{j} ) ℋ ( v ( {x}_{j} , t ) ) ∀ i ∈ 1 , … , N \qquad [ 2.11 ]$$

Here, xᵢ represents the position of nodes on a line; v(xᵢ, t) defines the voltage activity of sensor node positioned at xᵢ at time t; S (xᵢ, xⱼ) is the strength of connection between nodes positioned at xᵢ and xⱼ; τ_{d} controls the rate of decay of voltage activity; X is the set of all sensor nodes in the system (x₁, x₂, . . . , x_{N}) for N sensor nodes; and [symbol] is a non-linear function that converts activity of nodes to binary spiking/non-spiking. Here, [symbol] is the Heaviside function with a step transition at 0.

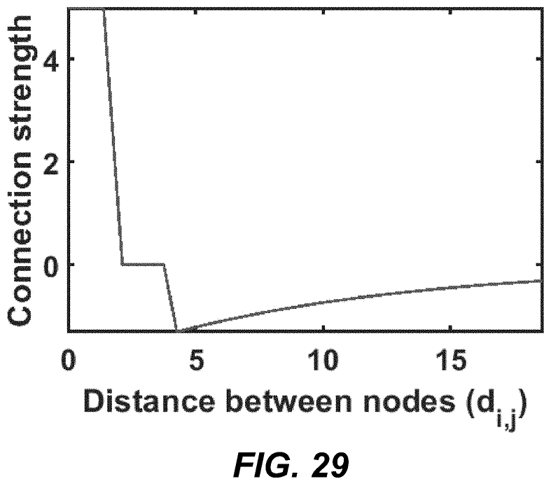

Each sensor-node has the same topology for its adjacency kernel, i.e. fixed strength of positive connections between nodes within a radius rⁱ, no connections from a radius rⁱ to r^{o}, and decaying inhibition above a radius r^{o} (FIG. 29).

### 13.1.1 Fixed Point Analysis

The stable activity states of nodes placed in a line is determined by a fixed point analysis.

v(xᵢ)=Σₓ_{ⱼ}_{∈X}S(xᵢ,xⱼ) [symbol] (v(xⱼ))∀i∈1, . . . ,N [2.12]

On solving this system of non-linear equations simultaneously, a fixed point i.e., a vector v*∈ [symbol] ^{N}, corresponding to the activity of N sensor nodes positioned at (x₁, x₂, . . . , x_{N}) is obtained. Their spiking from the activity of sensor-nodes is assessed using

sᵢ= [symbol] (v(xᵢ))∀i∈1, . . . ,N [2.13]

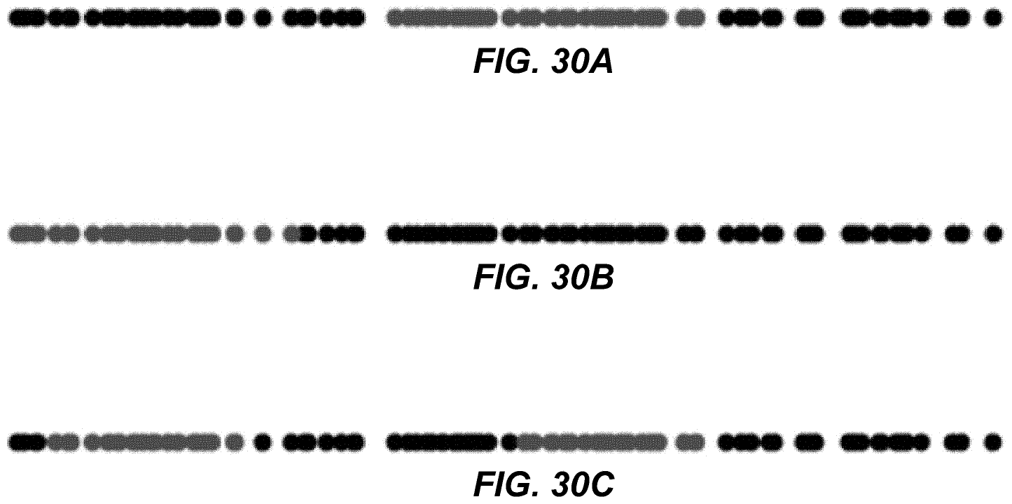

As the weight matrix (S(xᵢ, xⱼ)) used incorporates the local excitation (rₑ<2) and global inhibition (rᵢ >4) (FIG. 29), the following solutions are obtained: solutions with a single bump of activity (FIG. 30A), two bumps of activity (FIG. 30B) or a state when all nodes are active.

FIGS. 30A-30C: Fixed points: Multiple fixed points are obtained by solving N non-linear equations simultaneously. Some of the solutions obtained are: (FIG. 30A) a single bump at the center, (FIG. 30B) a single bump at one of the edges, and (FIG. 30C) two bumps of activity.

### 13.1.2 Stability of Fixed Points

To assess the stability of these fixed points, the eigenvalues of the Jacobian for this system of ordinary differential equations (ODEs) are evaluated. As there are N differential equations, the Jacobian ( [symbol] ) is an N×N matrix.

$$\frac{d v ( {x}_{i} , t )}{d t} = \frac{- v ( {x}_{i} , t )}{{τ}_{d}} + {\sum }_{{x}_{j} ∈ 𝒳} \frac{S ( {x}_{i} {x}_{j} ) ℋ ( v ( {x}_{j} ) )}{{τ}_{d}} \\ \frac{d v ( {x}_{i} , t )}{d t} = {f}_{i} ( {x}_{1} , {x}_{2} , … , {x}_{N} ) \\ {f}_{i} ( {x}_{1} , {x}_{2} , … , {x}_{N} ) = \frac{- v ( {x}_{i} )}{{τ}_{d}} + {\sum }_{{x}_{j} ∈ 𝒳} \frac{S ( {x}_{i} {x}_{j} ) ℋ ( v ( {x}_{j} ) )}{{τ}_{d}} \\ 𝕁 ( i , j ) = \frac{\partial {f}_{i} ( {x}_{1} , {x}_{2} , … , {x}_{N} )}{\partial v ( {x}_{j} )} \qquad [ 2.14 ]$$

Upon evaluating the Jacobian ( [symbol] ) at the fixed points obtained (v*), the following are obtained:

$$𝕁 ( i , i ) = \frac{\partial {f}_{i}}{\partial v ( {x}_{i} )} = \frac{1}{{τ}_{d}} ( \frac{- \partial v ( {x}_{i} )}{\partial v ( {x}_{i} )} + {\sum }_{{x}_{j} ∈ 𝒳} S ( {x}_{i} , {x}_{j} ) \frac{\partial ℋ ( v ( {x}_{j} ) )}{\partial v ( {x}_{i} )} ) \\ 𝕁 ( i , i ) = \frac{- 1}{{τ}_{d}} \\ 𝕁 ( i , j ) = S ( {x}_{i} , {x}_{j} ) {ℋ}^{′} ( v ( {x}_{j} ) ) \frac{\partial v ( {x}_{j} )}{\partial v ( {x}_{j} )} \\ 𝕁 ( i , j ) = S ( {x}_{i} , {x}_{j} ) δ ( v ( {x}_{j} ) ) \\ 𝕁 ( i , j ) = 0 ∀ v ( {x}_{j} ) \neq 0 \qquad [ 2.15 ]$$

Here, [symbol] is the Heaviside function and its derivative is the dirac-delta (δ); where, δ(v)=0, for v≠0 and δ(v)=∞ for v=0. Note that S(xᵢ, xᵢ)=0, ∀i∈1, . . . , N, since there is no adjacency from a neuron to itself.

For a fixed point, where v*(xₖ)≠0, ∀k∈1, . . . , N, the Jacobian is a diagonal matrix with

$$\frac{- 1}{{τ}_{d}}$$

in its diagonals. This implies mat the eigenvalues of the Jacobian are

$$\frac{- 1}{{τ}_{d}} ( {τ}_{d} > 0 ) ,$$

which assures that the fixed point v*∈ [symbol] ^{N} is a stable fixed point.

### 13.1.3 Destabilizing the Fixed Point Creating Wave Movement

The stable fixed point solution is an inherent property of the system and makes the fixed bump solutions (FIG. 30A) particularly robust. It is technically possible to destabilize a stable fixed point temporarily with a noisy source/input term ηᵢ(t) of high amplitude

$${τ}_{d} \frac{d v ( {x}_{i} , t )}{d t} = - v ( {x}_{i} , t ) + {\sum }_{{x}_{j} ∈ 𝒳} S ( {x}_{i} , {x}_{j} ) ℋ ( v ( {x}_{j} , t ) ) + {η}_{i} ( t ) ∀ i ∈ 1 , … , N \qquad [ 2.16 ]$$

where ηᵢ(t) models the noisy behavior of every node i in the system, with <ηᵢ(t)ηⱼ(t′)>=σ²δ_{i,j}δ(t−t′) (here δ_{i,j}, δ(t−t′) are Kronecker-delta and Dirac-delta functions respectively, σ² is magnitude of noise).

However, experiments show that this is not a reliable way of creating traveling waves of coherent spatiotemporal behavior. The reasons are: (1) With a given heterogeneous spatial distribution of neurons (and fixed coefficient matrix S(xᵢ, xⱼ)), the system tends to naturally gravitate back towards the same fixed points in space. (2) The bump of activity may randomly emerge at spatially arbitrary locations for very short time showing no behavior of coherent movement through space. (3) There is a rather narrow transition from the existence of the spatially coherent fixed points (bumps) to an incoherent spatiotemporal bursting solution across the entire domain (when noise ηᵢ(t) over-dominates the S(xᵢ, xᵢ) term).

The dynamics of the inherently stable fixed point in equation 2.11 are hard to modify with no additional equation that couples v the eigenvalues of an ODE system are not changed by a non-homogeneous input term. Hence, the dynamic threshold equation is introduced for θ in equation 2.5 that acts as a trade-off variable to v, effectively reducing the argument for the spike function [symbol] whenever v becomes large.

$${τ}_{d} \frac{d v ( {x}_{i} , t )}{dt} = - v ( {x}_{i} , t ) + {\sum }_{{x}_{j} ∈ 𝒳} S ( {x}_{i} , {x}_{j} ) ℋ ( v ( {x}_{j} , t ) - θ ( {x}_{j} , t ) ) + {η}_{i} ( t ) ∀ i ∈ 1 , … , N \qquad [ 2.17 ]$$

Wherever a fixed point (v higher than θ) emerges initially, the dynamic threshold equation will proceed to grow θ exactly at that position until θ surpasses v (and its growing ability) at that position, thus leaving the v fixed point no choice but to yield. Now, by choosing the time constant τ_{θ} an order of magnitude larger than τᵥ, thus making the dynamics of the θ recovery slower than the dynamics of v, the v bump cannot immediately return to the initial fixed point and must keep moving. That way, a coherent spatiotemporal movement is achieved.

This principle extends seamlessly to architectures with several layers. As the spike input term in each layer represents a non-homogeneous input to the ODE system of that layer, the dynamics of that layer (with its own respective v and θ) are not fundamentally changed or disrupted by a multi-layering of units and their inputs. Hence, this allows coherent waves to simultaneously exist in multiple layers of the SNN, each receiving inputs from its preceding layer.

### 13.2 Dynamics in Phase Space

The dominant dynamics of neurons in each of the layers is investigated by creating a space that tracks the voltage v of every neuron and its dynamic threshold (θ) over time. An SVD is performed to observe the dynamics in the phase space along the top-3 principal modes. The top-3 principal modes capture 83% of the variance of the dynamics of layer-1 neurons, 87% of the variance of layer-2 neurons, and 90% of the variance of layer-3 neurons.

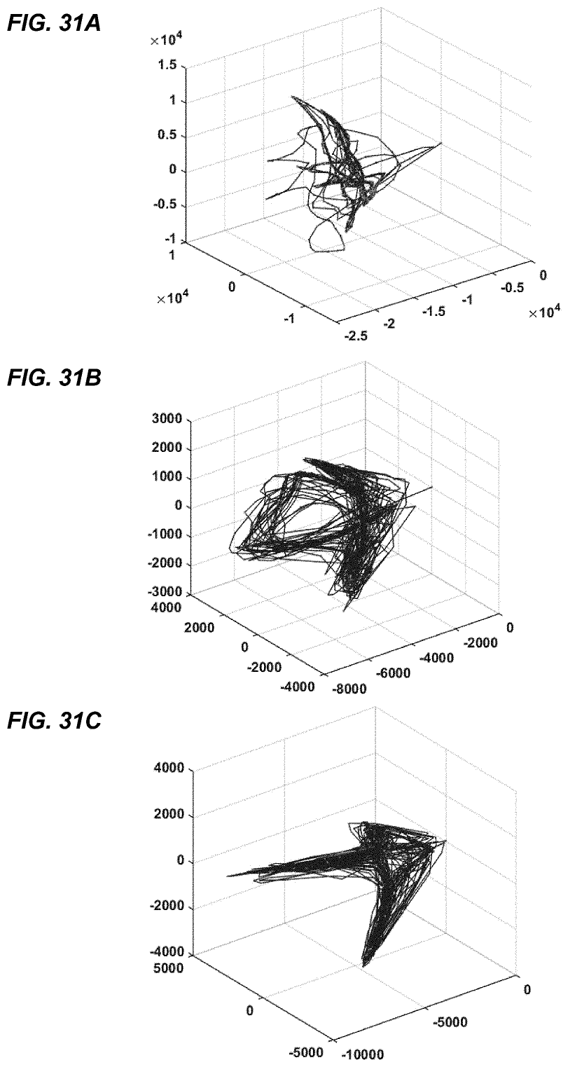

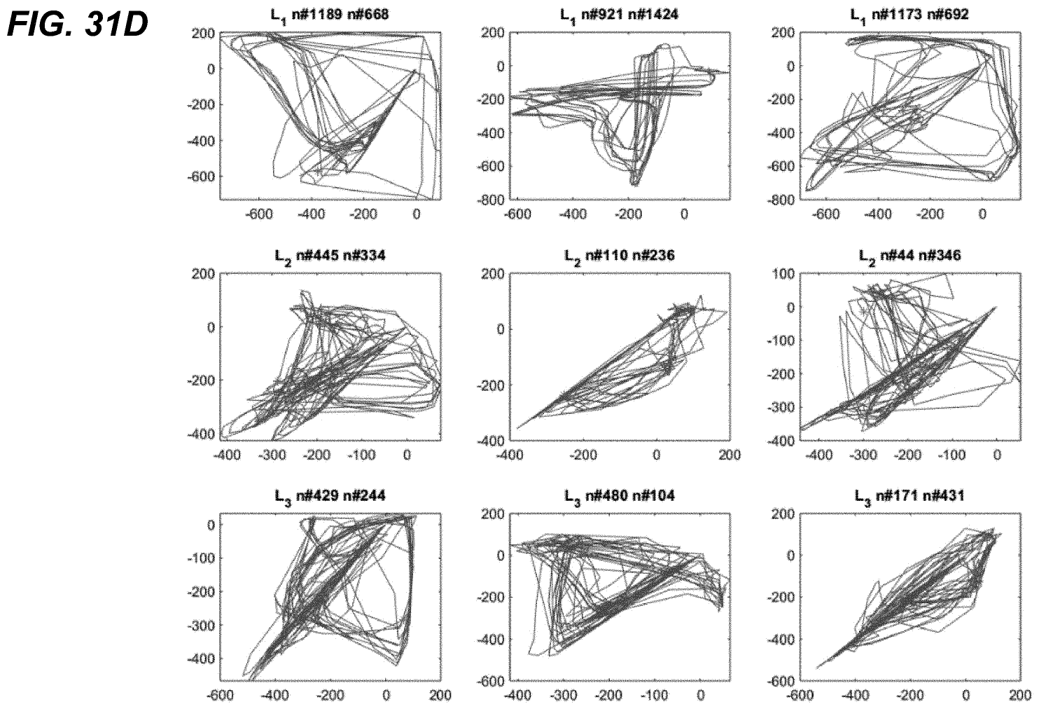

FIGS. 31A-31D. Dynamics in phase space. FIG. 31A (and the video available at https://drive.google.com/file/d/1pL01cwUK8k1KmGA-Nuz8Eg0mTFNOw6yO, which is incorporated herein by reference in its entirety). Phase-space dynamics of layer-2 in low-dimensional representation of dominant 3 SVD modes. FIG. 31B (and the video available at https://drive.google.com/file/d/1lHk92gj7Crk16MpkEXDHKs7jpmuYh8gP, which is incorporated herein by reference in its entirety). Phase-space dynamics of layer-2 in low-dimensional representation of dominant 3 SVD modes. FIG. 31C (and the video available at https://drive.google.com/file/d/1yQQ8z3KEruykX5qCRZYcepk3TEsgx23W, which is incorporated herein by reference in its entirety). Phase-space dynamics of layer-3 in low-dimensional representation of dominant 3 SVD. FIG. 31D (and the video available at https://drive.google.com/file/d/1Yo2kr4Pm2kHP06PYk8-AYrMn-s6DUV1E, which is incorporated herein by reference in its entirety). Dynamics in phase space—taking any 2.

### Execution Environment

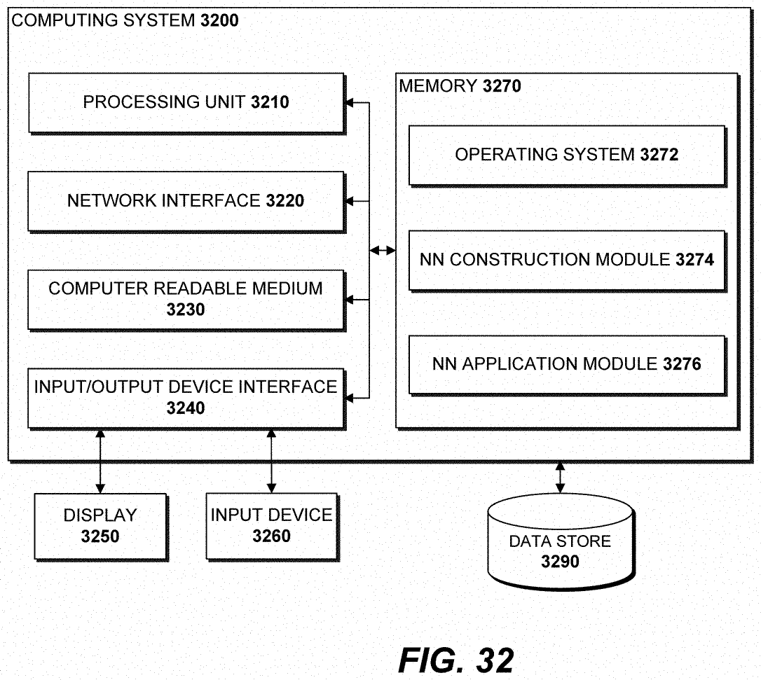

FIG. 32 depicts a general architecture of an example computing device 3200 configured to execute the processes and implement the features described herein. The general architecture of the computing device 3200 depicted in FIG. 32 includes an arrangement of computer hardware and software components. The computing device 3200 may include many more (or fewer) elements than those shown in FIG. 32. It is not necessary, however, that all of these generally conventional elements be shown in order to provide an enabling disclosure. As illustrated, the computing device 3200 includes a processing unit 3210, a network interface 3220, a computer readable medium drive 3230, an input/output device interface 3240, a display 3250, and an input device 3260, all of which may communicate with one another by way of a communication bus. The network interface 3220 may provide connectivity to one or more networks or computing systems. The processing unit 3210 may thus receive information and instructions from other computing systems or services via a network. The processing unit 3210 may also communicate to and from memory 3270 and further provide output information for an optional display 3250 via the input/output device interface 3240. The input/output device interface 3240 may also accept input from the optional input device 3260, such as a keyboard, mouse, digital pen, microphone, touch screen, gesture recognition system, voice recognition system, gamepad, accelerometer, gyroscope, or other input device.

The memory 3270 may contain computer program instructions (grouped as modules or components in some embodiments) that the processing unit 3210 executes in order to implement one or more embodiments. The memory 3270 generally includes RAM, ROM and/or other persistent, auxiliary or non-transitory computer-readable media. The memory 3270 may store an operating system 3272 that provides computer program instructions for use by the processing unit 3210 in the general administration and operation of the computing device 3200. The memory 3270 may further include computer program instructions and other information for implementing aspects of the present disclosure.

For example, in one embodiment, the memory 3270 includes a neural network (NN) construction module 3274 for constructing a neural network by growing and self-organizing a neural network. The memory 3270 may additionally or alternatively include a neural network application module 3276 for using a neural network constructed by growing and self-organizing to perform a task, such as a computation processing task, an information processing task, a sensory input processing task, a storage task, a retrieval task, a decision task, an image recognition task, and/or a speech recognition task. In addition, memory 3270 may include or communicate with the data store 3290 and/or one or more other data stores that store neural network constructed by growing and self-organizing and/or data used for constructing the neural network by growing and self-organizing.

### Additional Considerations

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

One skilled in the art will appreciate that, for this and other processes and methods disclosed herein, the functions performed in the processes and methods can be implemented in differing order. Furthermore, the outlined steps and operations are only provided as examples, and some of the steps and operations can be optional, combined into fewer steps and operations, or expanded into additional steps and operations without detracting from the essence of the disclosed embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. As used in this specification and the appended claims, the singular forms “a,” “an,” and “the” include plural references unless the context clearly dictates otherwise. Accordingly, phrases such as “a device configured to” are intended to include one or more recited devices. Such one or more recited devices can also be collectively configured to carry out the stated recitations. For example, “a processor configured to carry out recitations A, B and C can include a first processor configured to carry out recitation A and working in conjunction with a second processor configured to carry out recitations B and C. Any reference to “or” herein is intended to encompass “and/or” unless otherwise stated.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

It will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for example through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure and protected by the following claims.

1. A method for constructing a neural network comprising:
under control of a hardware processor:
growing, from at least one node, a plurality of layers of a neural network each comprises a plurality of nodes; and
self-organizing the plurality of layers of the neural network, using
spatiotemporal waves in a lower first layer of the plurality of layers of the neural network, and/or
a learning rule implemented in a higher second layer of the plurality of layers of the neural network connected to the lower first layer of the plurality of layers of the neural network,
to alter inter-layer connectivity between the lower first layer and the higher second layer.

2. The method of claim 1, wherein the at least one node comprises a single node.

3. The method of claim 1, wherein
growing, from the at least one node, the plurality of layers of the neural network comprises dividing the at least one node to generate a daughter node, of the at least one node, in the lower first layer.

4. The method of claim 3, comprising dividing the daughter node in the lower first layer to generate a further daughter node, of the daughter node of the at least one node, in the lower first layer.

5. The method of claim 3, comprising dividing the daughter node in the lower first layer to generate a further daughter node, of the daughter node of the at least one node, in the higher second layer.

6. The method of claim 1, wherein growing, from the at least one node, the plurality of layers of the neural network comprises dividing the at least one node to generate a daughter node, of the at least one node, in the higher second layer.

7. (canceled)

8. (canceled)

9. The method of claim 1, wherein an architecture of the lower first layer and higher second layer comprises a pooling architecture, and/or wherein an architecture of two layers of the plurality of layers comprises a pooling architecture.

10. The method of claim 1, wherein an architecture of the lower first layer and higher second layer comprises an expansion architecture, and/or wherein an architecture of two layers of the plurality of layers comprises an expansion architecture.

11. The method of claim 1, wherein the lower first layer and/or the higher second layer comprises a square geometry or a rectangular geometry.

12. The method of claim 1, wherein the lower first layer and/or the higher second layer comprises a non-rectangular geometry.

13. The method of claim 12, wherein the non-rectangular geometry comprises an annulus geometry, a spherical geometry, and/or disk geometry with a hyperbolic distribution.

14. The method of claim 1, wherein the neural network comprises a spiking node, and/or wherein the neural network comprises a spiking neural network.

15. (canceled)

16. The method of claim 1, wherein said growing is performed prior to said self-organizing.

17. The method of claim 1, wherein said growing and said self-organizing are performed over a first plurality of iterations.

18. The method of claim 17, wherein said growing is performed prior to said self-organizing in each of the plurality of iterations.

19. The method of claim 1, wherein said growing is performed over a first plurality of iterations followed by said self-organizing being performed over a second plurality iterations.

20. (canceled)

21. The method of claim 1, comprising generating the spatiotemporal waves based on noisy interactions between nodes of the first layer of the plurality of layers of the neural network.

22. The method of claim 1, wherein said self-organizing comprises applying structural training data to the lower first layer.

23. The method of claim 1, wherein the learning rule comprises a local learning rule, and/or wherein the learning rule comprises a dynamic learning rule.

24. (canceled)

25. The method of claim 1, comprising training a classifier connected to the plurality of layers and/or the neural network.

26. The method of claim 1, wherein the hardware processor comprises a neuromorphic processor.

27. A system comprising:
non-transitory memory configured to store executable instructions and a neural network trained by:
growing, from at least one node, a plurality of layers of a neural network each comprises a plurality of nodes; and
self-organizing the plurality of layers of the neural network, using
spatiotemporal waves in a lower first layer of the plurality of layers of the neural network, and/or
a learning rule implemented in a higher second layer of the plurality of layers of the neural network connected to the lower first layer of the plurality of layers of the neural network,
to alter inter-layer connectivity between the lower first layer and the higher second layer; and
a hardware processor in communication with the non-transitory memory, the hardware processor programmed by the executable instructions to:
perform a task using the neural network.

28.-32. (canceled)

33. A system comprising:
non-transitory memory configured to store executable instructions and a neural network trained by:
growing, from at least one node, a plurality of layers of a neural network each comprises a plurality of nodes; and
self-organizing the plurality of layers of the neural network, using
spatiotemporal waves in a lower first layer of the plurality of layers of the neural network, and/or
a learning rule implemented in a higher second layer of the plurality of layers of the neural network connected to the lower first layer of the plurality of layers of the neural network,
to alter inter-layer connectivity between the lower first layer and the higher second layer; and
a hardware processor in communication with the non-transitory memory, the hardware processor programmed by the executable instructions to:
further self-organize the plurality of layers of the neural network, using
spatiotemporal waves in a lower first layer of the plurality of layers of the neural network, and/or
a learning rule implemented in a higher second layer of the plurality of layers of the neural network connected to the lower first layer of the plurality of layers of the neural network,
to update inter-layer connectivity between the lower first layer and the higher second layer.

34. (canceled)
